(19) United States
(12) Patent Application Publication
(10) Pub. No.: US 2019/0109344 A1
(43) Pub. Date: Apr. 11, 2019

(54) TRANSITION METAL CATALYST NANOPARTICLES AND USES THEREOF

(71) Applicants: Liang WANG, Newark, DE (US); Weiqing ZHENG, Wilmington, DE (US); Ajay K. PRASAD, Newark, DE (US); Suresh G. ADVANI, Newark, DE (US); Dionisios G. VLACHOS, Voorhees, NJ (US)

(72) Inventors: Liang WANG, Newark, DE (US); Weiqing ZHENG, Wilmington, DE (US); Ajay K. PRASAD, Newark, DE (US); Suresh G. ADVANI, Newark, DE (US); Dionisios G. VLACHOS, Voorhees, NJ (US)

(73) Assignee: University of Delaware, Newark, DE (US)

(21) Appl. No.: 16/094,631

(22) PCT Filed: Apr. 25, 2017
(86) PCT No.: PCT/US17/29306

§ 371 Date: Oct. 18, 2018

Related U.S. Application Data
(60) Provisional application No. 62/326,882, filed on Apr. 25, 2016.

(51) Int. Cl. H01M 8/1051; H01M 8/02

(52) U.S. Cl. CPC H01M 8/1051; H01M 8/02; H01M 2008/1095; H01M 2300/0091; H01M 2300/0082

(57) ABSTRACT

The present disclosure is directed to microparticles comprising carbon, wherein a plurality of nanoparticles are supported on the surface of the microparticle. The nanoparticles comprise at least one transition metal compound selected from the group consisting of transition metal carbides, transition metal nitrides, transition metal sulfides, transition metal phosphides, transition metal carbonitrides, transition metal sulfonitrides, transition metal carbosulfides, transition metal phosphocarbides, transition metal phosphonitrides, transition metal phosphosulfides, transition metal carbosulfonitrides, transition metal carbophosphonitrides, transition metal phosphosulfonitrides, transition metal carbophosphosulfonitrides, and interstitial derivatives thereof. The present disclosure is also directed to processes for preparing such microparticles and to polymer electrolyte membranes (PEMs) that comprise such microparticles, as well as to the use of such PEMs in fuel cells.

### RELATED APPLICATIONS

This application claims priority to U.S. Provisional Patent Application Ser. No. 62/326,882, filed Apr. 25, 2016, which is hereby incorporated by reference herein in its entirety.

### GOVERNMENT LICENSE RIGHTS

This invention was made with government support under Grant No. DE-55-7002-00, awarded by the Federal Transit Administration and under Grant No. DE-SC0001004, awarded the U.S. Department of Energy, Office of Science, Office of Basic Energy Sciences through the Catalysis Center for Energy Innovations (CCEI). The government has certain rights in the invention

### FIELD OF THE INVENTION

The present disclosure relates generally to carbon microparticles having a plurality of nanoparticles supported on its surface, the nanoparticles comprising at least one transition metal-based catalyst selected from the group consisting of transition metal carbides, transition metal nitrides, transition metal sulfides, transition metal phosphides, transition metal carbonitrides, transition metal sulfonitrides, transition metal carbosulfides, transition metal phosphocarbides, transition metal phosphonitrides, transition metal phosphosulfides, transition metal carbosulfonitrides, transition metal carbophosphonitrides, transition metal phosphosulfonitrides, transition metal carbophosphosulfonitrides, and interstitial derivatives thereof. The present disclosure is also directed to processes for preparing such microparticles and to polymer electrolyte/proton exchange membranes (PEMs) that comprise such microparticles, as well as to the use of such PEMs in fuel cells.

### BACKGROUND OF THE INVENTION

Polymer electrolyte membrane fuel cells (PEMFCs) that employ a platinum catalyst and a PEM, such as a Nafion® membrane, are a cleaner and more efficient alternative to power generation than fossil fuel combustion. The potential for PEMFCs to replace the internal combustion engine in vehicles and generate power in both stationary and portable power applications has already been demonstrated. Yet, several challenges presently hinder broad commercial adoption and use of this technology, particularly among them PEM stability and the high cost of platinum.

Proton conductivity of the PEMs currently used in PEMFCs dictates performance and requires hydration of the PEM. Therefore, a core challenge for this technology is the maintenance the high proton conductivity at low humidity levels. Considerable efforts in the industry have been made to meet this challenge, for example, by adding hydrophilic materials to the PEM to improve the water retention capability. However, this approach does not significantly enhance fuel cell performance at low humidity due to limited access to water. Another technique involves introducing platinum nanoparticles into the PEM to catalyze the reaction of crossover H₂ and O₂ into H₂O, thus hydrating the membrane in situ. However, platinum also catalyzes the generation of H₂O₂ and free radicals such as OH. and HOO. in addition to the water, causing chemical degradation of the PEM, such as via cleavage of the carbon-sulfur bonds characteristic of Nafion® in membranes made from this ionomer. Moreover, adding platinum to the PEM further drives up the overall cost of the PEMFC.

Thus, there exists a continuing need for a low-cost catalyst which can improve PEMFC performance at low humidity levels by more efficiently catalyzing the reaction of crossover H₂ and O₂ into H₂O, so as to hydrate the PEM while simultaneously inhibiting its chemical degradation.

### EMBODIMENTS OF THE INVENTION

This need is met by the transition metal-based catalysts of the present invention. When incorporated into the PEM of a PEMFC, these catalysts are highly effective in hydrating the membrane via in situ catalysis of the reaction of crossover H₂ and O₂ into H₂O, resulting in increased fuel cell power density even in low humidity conditions, while simultaneously maintaining structural integrity and stability of the PEM by capturing free radical species generated at the cathode and inhibiting formation of free radical species associated with the use of platinum in this environment. The nanoparticles of the transition metal-based catalysts supported on carbon-based microparticles of the present invention can be synthesized via a scalable, two-step process that symbiotically combines two synthetic methodologies: hydrothermal carbonization (HTC) and temperature-programmed reduction-carburization/nitridation/sulfidation and/or phosphidation (TPRC/N/S/P).

Thus, one embodiment of the present invention is a microparticle comprising carbon and a plurality of nanoparticles comprising at least one transition metal compound selected from the group consisting of transition metal carbides, transition metal nitrides, transition metal sulfides, transition metal phosphides, transition metal carbonitrides, transition metal sulfonitrides, transition metal carbosulfides, transition metal phosphocarbides, transition metal phosphonitrides, transition metal phosphosulfides, transition metal carbosulfonitrides, transition metal carbophosphonitrides, transition metal phosphosulfonitrides, transition metal carbophosphosulfonitrides, and interstitial derivatives thereof, wherein the plurality of nanoparticles are supported on the surface of the microparticle.

In certain embodiments, the microparticle of the present invention further comprises one or more transition metals. In certain embodiments, these one or more transition metals are selected from the group consisting of tungsten, nickel, iron, cobalt, molybdenum, rhodium, iridium, zinc, copper, manganese, chromium, palladium, and platinum. In certain embodiments, the transition metal of the one or more transition metal compounds is selected from the group consisting of tungsten, nickel, iron, cobalt, molybdenum, rhodium, iridium, zinc, copper, manganese, chromium, palladium, platinum, and combinations thereof. In certain embodiments, the interstitial derivative comprises one or more transition metals selected from the group consisting of tungsten, nickel, iron, cobalt, molybdenum, rhodium, iridium, zinc, copper, manganese, chromium, platinum, and palladium. In certain embodiments, the nanoparticles comprise tungsten carbide.

In certain embodiments, the microparticle of the present invention is substantially spherical. In certain embodiments, the average particle size of the microparticle is 30 μM or less. In certain other embodiments, the average particle size of the microparticle is 10 μM or less. In certain embodiments, the microparticle is spherical and has a diameter in the range of from 1.5 μM to 10 μM. In certain other embodiments, the microparticle is spherical and has a diameter in the range of from 3 μM to 5 μM.

In certain embodiments, the surface of the microparticle of the present invention is smooth and the plurality of nanoparticles are substantially uniformly dispersed over the surface of the microparticle. In certain embodiments, the average particle size of the nanoparticles is 5 nM or less. In certain other embodiments, the average particle size of the nanoparticles is in the range of from 3 nM to 5 nM. In certain embodiments, the nanoparticles have a core/shell structure.

Another embodiment of the present invention is a membrane comprising a plurality of the microparticles of the present invention, wherein the transition metal of the one or more transition metal compounds is selected from the group consisting of tungsten, cobalt, molybdenum, rhodium, iridium, zinc, copper, manganese, chromium, and combinations thereof.

In certain embodiments, the membrane of the present invention comprises an ionomer. In certain embodiments, the ionomer comprises one or more functional groups selected from the group consisting of sulfonic acid/sulfonate groups, phosphonic acid/phosphonate groups, and carboxylic acid/carboxylate groups. In certain embodiments, the membrane comprises a poly(perfluorosulfonic acid). In certain embodiments, the poly(perfluorosulfonic acid) is a tetrafluoroethylene-based copolymer.

In certain embodiments, the membrane of the present invention further comprises one or more transition metals selected from the group consisting of tungsten, cobalt, molybdenum, rhodium, iridium, zinc, copper, manganese, chromium, platinum, and palladium. In certain embodiments, the membrane comprises a plurality of the microparticles of the present invention, the nanoparticles of which comprise tungsten carbide.

In certain embodiments, the microparticles are present in the membrane of the present invention in a concentration in the range of from 1% to 10% by weight, based on the total weight of the membrane. In certain embodiments, the microparticles are uniformly distributed throughout the membrane. In certain embodiments, the concentration of the microparticles in the membrane varies transversely across the membrane. In certain embodiments, the concentration of the microparticles in the membrane increases or decreases in a gradient transversely across the membrane.

In certain embodiments, the membrane of the present invention has a thickness in the range of from 10 μM to 100 μM. In certain other embodiments, the membrane has a thickness in the range of from 15 μM to 25 μM.

In certain embodiments, the membrane of the present invention is reinforced. In certain embodiments, the membrane is reinforced with polytetrafluoroethylene and/or carbon nanotubes. In certain embodiments, the reinforcement is located in the center of the membrane or closer to one surface of the membrane relative to the other surface of the membrane.

Yet another embodiment of the present invention is a process for preparing a microparticle of the present invention comprising carbon and a plurality of nanoparticles comprising one or more transition metal compounds selected from the group consisting of transition metal carbides, transition metal nitrides, transition metal sulfides, transition metal phosphides, transition metal carbonitrides, transition metal sulfonitrides, transition metal carbosulfides, transition metal phosphocarbides, transition metal phosphonitrides, transition metal phosphosulfides, transition metal carbosulfonitrides, transition metal carbophosphonitrides, transition metal phosphosulfonitrides, and/or transition metal carbophosphosulfonitrides, the process comprising the steps of: (a) subjecting a mixture of (1) one or more precursors comprising a transition metal and (2) a precursor comprising carbon to hydrothermal carbonization to form an intermediate; and (b) subjecting the intermediate formed in (a) to temperature-programmed reduction-carburization, temperature-programmed reduction-nitridation, a temperature-programmed reduction-sulfidation, and/or a temperature-programmed reduction phosphidation to form a microparticle comprising carbon and a plurality of nanoparticles comprising a transition metal carbide, transition metal nitride, transition metal sulfide, transition metal phosphide, transition metal carbonitride, transition metal sulfonitride, transition metal carbosulfide, transition metal phosphocarbide, transition metal phosphonitride, transition metal phosphosulfide, transition metal carbosulfonitride, transition metal carbophosphonitride, transition metal phosphosulfonitride, and/or transition metal carbophosphosulfonitride.

In certain embodiments, the process of the present invention produces a microparticle comprising carbon wherein the plurality of nanoparticles is supported on the surface of the microparticle.

In certain embodiments of the process of the present invention, the transition metal of the precursor comprising one or more transition metals is selected from the group consisting of tungsten, nickel, iron, cobalt, molybdenum, rhodium, iridium, zinc, copper manganese, chromium, platinum, palladium, and combinations thereof. In certain embodiments, the precursor comprising one or more transition metals comprises ammonium metatungstate hydrate.

In certain embodiments of the process of the present invention, the precursor comprising carbon is a water-soluble carbohydrate obtained from food and/or lignocellulosic biomass. In certain embodiments, the precursor comprising carbon is selected from the group consisting of C₅ and C₆ sugars and their oligomers. In certain embodiments, the precursor comprising carbon is selected from the group consisting of glucose, sucrose, fructose, galactose, and combinations thereof.

In certain embodiments of the process of the present invention, the process further comprises ball milling the intermediate formed in step (a) prior to step (b). In certain embodiments, the process further comprises post-treatment of the microparticle formed in (b) to form an interstitial derivative of the transition metal carbide, transition metal nitride, transition metal sulfide, transition metal phosphide, transition metal carbonitride, transition metal sulfonitride, transition metal carbosulfide, transition metal phosphocarbide, transition metal phosphonitride, transition metal phosphosulfide, transition metal carbosulfonitride, transition metal carbophosphonitride, transition metal phosphosulfonitride, and/or transition metal carbophosphosulfonitride. In certain embodiments, the post-treatment is selected from the group consisting of atomic layer deposition and colloidal synthesis. In certain embodiments, the interstitial derivative formed by this post-treatment comprises one or more transition metals selected from the group consisting of tungsten, nickel, iron, cobalt, molybdenum, rhodium, iridium, zinc, copper, manganese, chromium, platinum, and palladium.

Yet another embodiment of the present invention is a fuel cell comprising an anode, a cathode, an anode catalyst, and a membrane of the present invention.

### BRIEF DESCRIPTION OF THE DRAWINGS

FIG. 1 depicts a schematic of an embodiment of the method for synthesizing transition metal carbide, nitride, and/or carbonitride nanoparticles supported on carbon-based microparticles according to the present invention.

FIG. 2 depicts electron microscopy images of tungsten carbide nanoparticles supported on carbon-based microparticles according to the present invention (hereinafter referred to as “tungsten carbide nanoparticles” solely for the sake of simplicity).

FIG. 3 depicts SEM image and EDX mapping of tungsten carbide nanoparticles cut by a focused ion beam.

FIG. 4 depicts bright field TEM images of tungsten carbide nanoparticles.

FIG. 5 depicts powder x-ray diffraction (XRD) patterns of Nafion®, tungsten carbide nanoparticles, and a composite of Nafion® with 5% by weight of tungsten carbide nanoparticles.

FIG. 6 depicts powder XRD patterns of tungsten-based samples collected after the HTC step of the process according to the present invention after annealing in helium at 500, 700, and 900° C.

FIG. 7 depicts a thermogravimetric analysis of tungsten carbide nanoparticles.

FIG. 8 depicts X-ray photoelectron spectroscopy (XPS) W4f, C1s, O1s, and valence spectra of commercial WO₃, commercial tungsten carbide, WOₓ, nanoparticles, and tungsten carbide nanoparticles.

FIG. 9 depicts a SEM image of commercial tungsten carbide catalyst.

FIG. 10 depicts comparative performance, proton conductivity, durability, and relative maximum power density of fuel cells using recast Nafion® membranes and composite membranes of recast Nafion® with 5% by weight of commercial tungsten carbide, platinum, and tungsten carbide nanoparticles, respectively.

FIG. 11 depicts comparative fuel cell performance of baseline recast Nafion® membrane and composite membranes of recast Nafion® with commercial tungsten carbide, platinum black, and tungsten carbide nanoparticles.

FIG. 12 depicts linear fit accelerated durability tests of recast Nafion® membrane and composite membranes of recast Nafion® with commercial tungsten carbide, platinum black, and tungsten carbide nanoparticles.

FIG. 13 depicts a cross-section SEM image of platinum/Nafion® and tungsten carbide nanoparticle/Nafion® composite membranes collected after 100 hours of accelerated durability testing.

FIG. 14 depicts FIB-SEM tomography images of fresh composite membranes of Nafion® with platinum and tungsten carbide nanoparticles and used Nafion® membranes and composite membranes of Nafion® with platinum and tungsten carbide nanoparticles.

FIG. 15 depicts accelerated fuel cell durability tests of composite membranes of recast Nafion® with 5% by weight of platinum nanoparticles.

FIG. 16 depicts gas crossover and vacancy volume percentages estimated by the tomography of recast Nafion® membrane and composite membranes of recast Nafion® with commercial tungsten carbide, platinum black, and tungsten carbide nanoparticles after 100 hours of durability tests.

FIG. 17 depicts a schematic of the interaction of platinum or tungsten carbide nanoparticles supported on a carbon-based microparticle with radicals in solution.

FIG. 18 depicts a potential free energy diagram for the formation of OH. from H₂ and O₂ on platinum and tungsten carbide.

FIG. 19 depicts polarization curves of fuel cells using tungsten carbide nanoparticles as anode and cathode catalyst.

FIG. 20, depicts a SEM image, a low magnification TEM image, a high magnification TEM image, and a high resolution TEM image of a molybdenum carbide (Mo₂C) nanoparticles supported on carbon-based microparticle according to the present invention.

### DETAILED DESCRIPTION OF THE INVENTION

In one aspect of the present invention, the present disclosure provides for novel microparticles that comprise carbon and a plurality of nanoparticles, wherein the plurality of nanoparticles are supported on the surface of the microparticle.

As used herein, the term “supported” is defined as any a chemical, physical, and/or electrostatic bond between the microparticle and the nanoparticle(s) that results in their attachment to each other. In certain embodiments, the nanoparticles are embedded into the surface of the microparticle. In certain of these embodiments, any amount of up to 100% of the volume of the nanoparticle is embedded into the surface of the microparticle.

In certain embodiments, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the volume of the nanoparticle is embedded into the surface of the microparticle. Furthermore, to the extent that more than about 50% of the volume of the nanoparticle is embedded into the surface of the microparticle, these nanoparticles may alternatively be referred to as “nanodomains” on the surface of the microparticle.

The nanoparticles comprise one or more transition metal compounds. Any suitable transition metal compound may be used. Examples of classes of such transition metal compounds include, but are not limited to, transition metal carbides, transition metal nitrides, transition metal sulfides, transition metal phosphides, transition metal carbonitrides, transition metal sulfonitrides, transition metal carbosulfides, transition metal phosphocarbides, transition metal phosphonitrides, transition metal phosphosulfides, transition metal carbosulfonitrides, transition metal carbophosphonitrides, transition metal phosphosulfonitrides, transition metal carbophosphosulfonitrides. The transition metal compounds of the present invention may contain any suitable transition metal. Examples of such transition metals include, but are not limited to, tungsten, nickel, iron, cobalt, molybdenum, rhodium, iridium, zinc, copper, manganese, chromium, palladium, platinum, and combinations thereof. In certain embodiments, the nanoparticles of the present invention comprise tungsten carbide (i.e., WC). In certain other embodiments, the nanoparticles of the present invention comprise molybdenum carbide (i.e., Mo₂C).

In certain embodiments, the nanoparticles can comprise one or more interstitial derivatives of such transition metal compounds. As used herein, the term “interstitial derivative” is defined as any transition metal compound suitable for use in the nanoparticles of the present invention which contains or has been modified to contain one or more atoms that sit within an interstitial hole in the crystal lattice of the transition metal compound. In certain embodiments, these one or more atoms are transition metals. Examples of such transition metals include, but are not limited to, tungsten, nickel, iron, cobalt, molybdenum, rhodium, iridium, zinc, copper, manganese, chromium, platinum, and palladium. In certain embodiments, the transition metal is platinum. The interstitial derivatives of the present invention may be a uniform mixture or a random mixture. In certain embodiments, the interstitial derivative is a long range ordered structure (i.e., the crystal structure of the underlying transition metal compound is ordered).

As used herein, the term “microparticle” is defined as any particle having a particle size in the range of from 1 μM to 100 μM. In certain embodiments, the average particle size of the microparticle of the present invention is 30 μM or less. In certain other embodiments, the average particle size of the microparticle is 10 μM or less. In yet certain other embodiments, the average particle size of the microparticle of the present invention is 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1 μM or falls within a range of any two values in this list. As used herein, the term “nanoparticle” is defined as any particle having a particle size in the range of from 1 nM to less than 1 μM. In certain embodiments, the average particle size of the nanoparticles is 5 nM or less. In certain other embodiments, the average particle size of the nanoparticles is in the range of from 3 nM to 5 nM. In yet certain other embodiments, the average particle size of the nanoparticle of the present invention is 5, 4, 3, 2, or 1 nM or falls within a range of any two values in this list.

The microparticles and the nanoparticles thereon can be of any suitable shape. Examples of such shapes include, but are not limited to, spherical, spheroid, oblate spheroid, prolate spheroid, and ovoid. These particles, particularly the nanoparticles, can also be irregularly shaped. In certain embodiments, the microparticles and/or the nanoparticles of the present invention are spherical or spheroid in shape. In certain embodiments, the microparticles and/or the nanoparticles of the present invention are microspheres and/or nanospheres, respectively. Thus, the microparticles and the nanoparticles thereon can be any combination of size and shape. In certain embodiments, the microparticle of the present invention is spherical or spheroid and has a diameter in the range of from 1.5 μM to 10 μM. In certain other embodiments, the microparticle of the present invention is spherical or spheroid has a diameter in the range of from 3 μM to 5 μM.

The microparticles of the present invention, with the exception of the nanoparticles present on its surface, may or may not have an otherwise smooth surface (i.e., the surface of the microparticle may be rough or smooth outside of the presence of the nanoparticles on its surface. Furthermore, the plurality of nanoparticles may be uniformly, substantially uniformly, or unevenly dispersed or distributed over the surface of the microparticle. In certain embodiments, the surface of the microparticle is smooth and the plurality of nanoparticles are substantially uniformly dispersed over the surface of the microparticle.

The microparticle portion of the microparticles of the present invention themselves can further comprise one or more transition metals. Examples of such transition metals include, but are not limited to, tungsten, nickel, iron, cobalt, molybdenum, rhodium, iridium, zinc, copper, In certain embodiments, these transition metal compounds are catalysts manganese, chromium, palladium, and platinum.

The nanoparticles according to the present invention may have a core/shell structure. In other words, the nanoparticle comprises a core comprising the transition metal compound, on top of which are situated one or more layers (i.e., one or more shells) comprising one or more materials other than the transition metal compound. In certain embodiments, the shell comprises a material possessing catalytic activity. In certain of these embodiments, the material possessing catalytic activity is platinum or nickel.

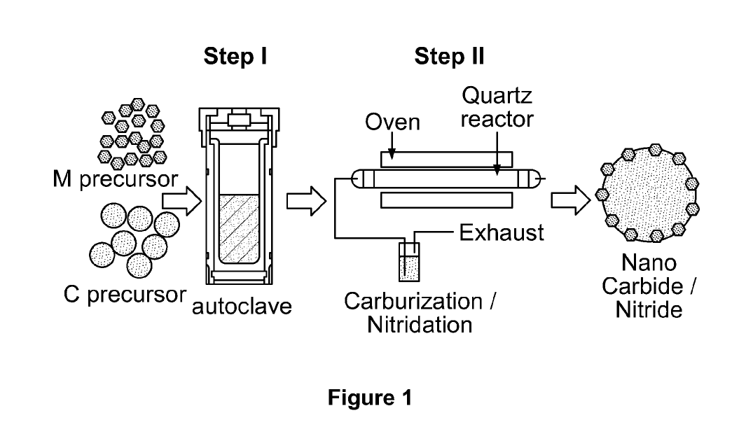

In another aspect of the present invention, the present disclosure provides for a process for preparing the above microparticles of the present invention. At a minimum, the process comprises the steps of (1) subjecting a mixture of (A) one or more precursors comprising a transition metal and (B) a precursor comprising carbon to hydrothermal carbonization to form an intermediate and (2) subjecting the intermediate formed in step (1) to temperature-programmed reduction-carburization, temperature-programmed reduction-nitridation, a temperature-programmed reduction-sulfidation, and/or a temperature-programmed reduction-phosphidation. A schematic of this process for synthesizing transition metal carbide, nitride, and/or carbonitride nanoparticles supported on carbon-based microparticles according to the present invention is shown in FIG. 1. During the first step of the process, solid carbon spheres are formed through dehydration and polymerization reactions, which can encapsulate the transition metal precursor nanoparticles. During the second step of the process, the carbon microparticle serves as a “spacer” to restrict the sintering of the transition metal compound particles, allowing for uniform or substantially uniform distribution of the nanoparticles over the surface of the microparticle. This efficient, scalable process results in stable transition metal compound nanoparticles having a high surface area and narrow size distribution supported on carbon-based microparticles. In certain embodiments, the process of the present invention further comprises ball milling the intermediate formed in step (1) prior to step (2).

The hydrothermal carbonization step of the process of the present invention may generally involve charging a reactor vessel capable of withstanding high temperatures and pressure and optionally having a non-reactive interior surface, such as, for example, a Teflon-lined autoclave with an aqueous solution of one or more transition metal precursors and precursors comprising carbon and subjecting the solution to high temperature, such as in a muffle furnace for example, and pressure, such as by pressuring the reactor with an inert gas, such as N₂ or helium, for example, for a period of time. The reactor can be heated and pressurized to any temperature or pressure suitable to effect dehydration and polymerization of the precursor comprising carbon. Examples of such temperatures and pressures respectively include, but are not limited to, 150° C., 160° C., 170° C., 180° C., 190° C., 200° C., 210° C., 220° C., 230° C., 240° C., and 250° C., or falls within a range of any two values in this list and 150, 160, 170, 180, 190, 200, 210, 220, 230, 240, and 250 psi or falls within a range of any two values in this list. The mixture of transition metal precursor and precursor comprising carbon can be in any concentration and the transition metal precursor and precursor comprising carbon can be in any relative ratio suitable to effect dehydration and polymerization of the precursor comprising carbon. Examples of relative ratios of transition metal precursor to precursor comprising carbon include but are not limited to 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, and 1:20 or falls within a range of any two values in this list. The mixture can also be stirred while undergoing hydrothermal carbonization. Examples of stirring speeds include, but are not limited to, 100, 200, 300, 400, 500, 600, 700, 800, 900, 1000, 1100, 1200, 1300, 1400, 1500, 1600, 1700, 1800, 1900, and 2000 rpm or falls within a range of any two values in this list. The pH of the mixture can also be adjusted to any pH suitable to effect dehydration and polymerization of the precursor comprising carbon. Examples of such pH include, but are not limited to, 1.0, 2.0, 3.0, 4.0, 5.0, 6.0, 7.0, 8.0, 9.0, 10.0, 11.0, 12.0, 13.0, and 14.0 or falls within a range of any two values in this list.

The temperature-programmed reduction-carburization, -nitridation, -sulfidation, and/or -phosphidation step of the process of the present invention may generally involve charging a reactor vessel capable of withstanding high temperatures and pressure, such as tubular quartz reactor for example, with the intermediate generated in the first step of the process of the present invention. Depending on whether the intermediate is to be -carburized, -nitrided, -sulfided, -phosphided, or any combination thereof, H₂ and a hydrocarbon, such as CH₄, (carburization), ammonia (nitridation), hydrogen sulfide (sulfidation) can be fed into the reactor, and/or red phosphorus can be mixed with the intermediate prior to charging to the reactor vessel or charged to the reactor vessel prior to addition of the intermediate to the vessel. The intermediate may be calcined in the presence of an inert gas prior to charging to the reactor vessel. The reactor is then heated to and held at a temperature for a period of time suitable to produce microparticles according to the present invention. Examples of suitable temperatures include, but are not limited to, 100, 200, 300, 400, 500, 600, 700, 800, 900, 1000, 1100, 1200, 1300, 1400, and 1500 or falls within a range of any two values in this list. In the case of carburization, the hydrogen and hydrocarbon can be in any suitable ratio, such as 10:1, 9:1, 8:1, 7:1, 6:1, 5:1, 4:1, 3:1, 2:1, and 1:1 or falls within a range of any two values in this list.

Any transition metal precursor (A) suitable for forming a transition metal carbide, transition metal nitride, transition metal sulfide, transition metal phosphide, transition metal carbonitride, transition metal sulfonitride, transition metal carbosulfide, transition metal phosphocarbide, transition metal phosphonitride, transition metal phosphosulfide, transition metal carbosulfonitride, transition metal carbophosphonitride, transition metal phosphosulfonitride, and/or transition metal carbophosphosulfonitride according to the process of the present invention may be used. Examples of such transition metal precursors include, but are not limited to, precursors that contain tungsten, nickel, iron, cobalt, molybdenum, rhodium, iridium, zinc, copper manganese, chromium, platinum, palladium, and combinations thereof. Examples of specific transition metal precursors include, but are not limited to, ammonium metatungstate hydrate, tungsten(IV) chloride, tungsten (VI) chloride, ammonium paratungstate hydrate, and ammonium heptamolybdate. In certain embodiments, the precursor is ammonium metatungstate hydrate.

Any precursor comprising carbon suitable for forming a transition metal carbide, transition metal nitride, transition metal sulfide, transition metal phosphide, transition metal carbonitride, transition metal sulfonitride, transition metal carbosulfide, transition metal phosphocarbide, transition metal phosphonitride, transition metal phosphosulfide, transition metal carbosulfonitride, transition metal carbophosphonitride, transition metal phosphosulfonitride, and/or transition metal carbophosphosulfonitride according to the process of the present invention may be used. In certain embodiments, the precursor comprising carbon is a water-soluble carbohydrate obtained from food and/or lignocellulosic biomass. In certain other embodiments, the precursor comprising carbon is selected from the group consisting of C₅ and C₆ sugars and their oligomers. In yet certain other embodiments, the precursor comprising carbon is selected from the group consisting of glucose, sucrose, fructose, galactose, and combinations thereof.

Interstitial derivatives and/or core/shell structures according to the present invention can form naturally during the process of synthesizing the microparticles of the present invention. Alternatively, the process of the present invention may further comprise post-treating the microparticle formed in step (2) to form an interstitial derivative and/or a core/shell structure according to the present invention. For example, one or more “shells” of materials other than transition metal compound “core” can be applied to the core after synthesis of the microparticles of the present invention. Such shells or layers can be applied to the core or interstitial derivatives may be synthesized by any suitable means known in the art for depositing a single layer of material on the core. Examples of such means include, but are not limited to, atomic layer deposition, chemical vapor deposition, reaction limited deposition, and colloidal synthesis.

In another aspect of the present invention, the present disclosure provides for various uses of the above microparticles of the present invention. In general, they can be used as catalysts in any chemical reactions that might employ noble metal catalysts, such as hydrogenation, dehydrogenation, hydrogenolysis, isomerization, ammonia synthesis/decomposition, and electrochemical reactions. In particular, they can be used as catalysts in various capacities, such as PEMs and as electrodes, in hydrogen fuel-based fuel cells, such as PEMFCs.

The microparticles of the present invention can be incorporated into PEMs as catalysts for use in improving the performance of PEMFCs. Such membranes comprise a plurality of microparticles of the present invention, the nanoparticles supported on which comprise a transition metal compound, the transition metal of which is selected from the group consisting of tungsten, cobalt, molybdenum, rhodium, iridium, zinc, copper, manganese, chromium, and combinations thereof. In certain embodiments, the nanoparticles of such membranes comprise tungsten carbide (i.e., WC). In certain other embodiments, the nanoparticles of such membranes comprise molybdenum carbide (i.e., Mo₂C). The use of such PEMs in PEMFCs can improve PEMFC performance at low humidity levels by more efficiently catalyzing the reaction of crossover H₂ and O₂ into H₂O, so as to hydrate the PEM while simultaneously inhibiting its chemical degradation.

The base material of the membrane of the present invention can be any suitable proton conducting material, such as a polymer. In certain embodiments, the proton conducting base material of the membrane is an ionomer. In certain embodiments, the ionomer comprises one or more functional groups selected from the group consisting of sulfonic acid/sulfonate groups, phosphonic acid/phosphonate groups, and carboxylic acid/carboxylate groups. Examples of such ionomers include, but are not limited to poly(perfluorosulfonic acids), sulfonated polyethylene oxides, polybenzimidazole/phosphoric acid blends, sulfonated polysulfones, sulfonated polyether sulfones, sulfonated polystyrenes, sulfonated perfluorovinyl ethers, sulfonated polyetherketones, sulfonated polyolefins, and mixtures and copolymers thereof. In certain embodiments, the ionomer is a poly(perfluorosulfonic acid). In certain of these embodiments, the poly(perfluorosulfonic acid) is a tetrafluoroethylene-based copolymer, such as Nafion®. In certain embodiments, the membranes of the present invention further comprise one or more transition metals. Examples of such transition metals includes, but is not limited to, tungsten, cobalt, molybdenum, rhodium, iridium, zinc, copper, manganese, chromium, platinum, and palladium. In certain embodiments, the membranes of the present invention further comprise platinum.

The microparticles of the present invention can be present in any suitable concentration to effectively catalyze the reaction of crossover H₂ and O₂ into H₂O. Examples of such concentrations include, but are not limited to, 1, 2, 3, 4, 5, 6, 7, 8, 9, 10, 11, 12, 13, 14, 15, 16, 17, 18, 19, 20, 21, 22, 23, 24, and 25% by weight, based on the total weight of the membrane, or falls within a range of any two values in this list. In certain embodiments, the microparticles are present in the membrane in a concentration in the range of from 1% to 10% by weight, based on the total weight of the membrane. The microparticles of the present invention can be either randomly or uniformly distributed throughout the membrane. In certain embodiments, the concentration of the microparticles in the membrane varies transversely across the membrane. In certain other embodiments, the concentration of the microparticles in the membrane increases or decreases in a gradient transversely across the membrane.

The membranes according to the present invention can be fabricated by any suitable method known in the art. Such membranes can be fabricated to have any thickness suitable for its use in a fuel cell. Examples of such thicknesses include, but are not limited to, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100 μM or falls within a range of any two values in this list. In certain embodiments, the membrane has a thickness in the range of from 10 μM to 100 μM. In certain other embodiments, the membrane has a thickness in the range of from 15 μM to 25 μM. The membranes of the present invention can also be fabricated with reinforcement. In certain embodiments, the membrane is reinforced with polytetrafluoroethylene and/or carbon nanotubes. In certain other embodiments, the reinforcement is located in the center of the membrane or closer to one surface of the membrane relative to the other surface of the membrane.

The membranes of the present invention can be employed in hydrogen fuel-based fuel cells, such as PEMFCs, in conjunction with other typical and conventional fuel cell components, such as anodes, cathodes, and anode and/or cathode catalysts.

The following examples are included to demonstrate preferred embodiments. It should be appreciated by those of skill in the art that the techniques disclosed in the examples which follow represent techniques discovered by the inventor to function well in the practice of the products, compositions, and methods described herein, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosure.

### Examples

### Inventive Example 1—Synthesis of Tungsten Carbide Nanoparticles

A 50 mL non-stirred Teflon-lined autoclave was charged with 35 mL of an aqueous solution of ammonium metatungstate hydrate (Sigma-Aldrich) and D(+)-glucose (Sigma-Aldrich), the pH of which was adjusted to 9.2. The charged autoclave was pressurized with N₂ to 200 psi at ambient temperature and then placed in a temperature-programmed muffle furnace and heated to 200° C. for 2 hours under stirring at around 800 rpm. The reaction mixture was filtered to obtain a solid paste, which was washed with 4×500 mL deionized water and dried overnight at 110° C. and calcined in the presence of helium to obtain the intermediate.

A tubular quartz reactor was charged with the calcined intermediate. A mixture of H₂ and CH₄ in a ratio of 4:1 (H₂:CH₄) was fed into the reactor. The reactor was then heated to and held at a temperature of 700° C. for 6 hours to obtain tungsten carbide nanoparticles supported on carbon microparticles according to the present invention.

Surface Morphology and Three-Dimensional (3D) Structure

The surface morphology and 3D structure of the tungsten carbide nanoparticles was investigated with a cross-beam SEM with a Ga+ ion source FIB (Auriga-60, ZEISS). A sample was mounted on a cross-section sample holder facing the ion column, while the SEM images were recorded from a side view at an angle of 54°. The Ga+ ion beam used to mill the sample was operated with an energy of 30 kV, and a current of 600 pA. A 1 μM thick platinum thin-film was deposited in situ on the sample's surface in order to prevent damage to the surrounding regions during milling. The 3D milled volume was 20 μM wide×20 μM long×12 μM deep. A total of 1000 2D slices were collected at a depth resolution of 12 nM. Each 2D slice was imaged at 2058×2058 pixels with an e-beam energy of 3 kV and an in-lens detector for high-contrast imaging. The 3D reconstruction of the sample was performed with the analytical software Avizo 7 (FEI Company).

HAADF images and 3D tomography characterization were acquired on a FEI Talos F200C microscope equipped with a FEG emitter.

HRTEM images were obtained with a JEOL JEM-2010F transmission electron microscope equipped with a field emission gun (FEG) emitter.

XRD patterns of catalyst and catalyst/Nafion® composite membranes were performed with a Bruker D8 Discover diffractometer using CuKα radiation (XK=1.540 Å). Measurements were taken over the range of 5°<2θ<95° with a step size of 0.05° and a count time of 1 second at each point.

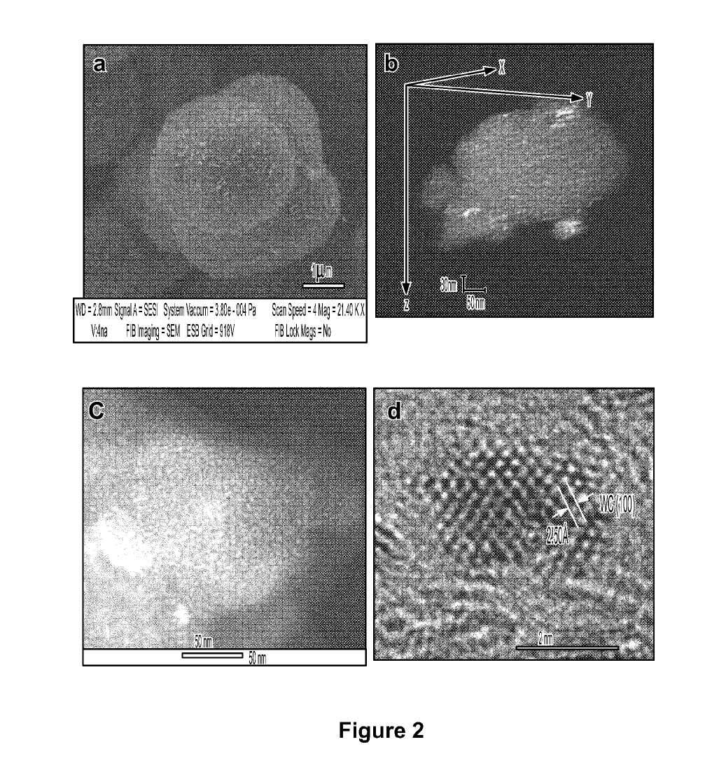

The morphology of tungsten carbide nanoparticles according to the present invention is shown in FIGS. 2a, 2b, 2c, 2d, 3, 4a, 4b, 5a, and 5b.

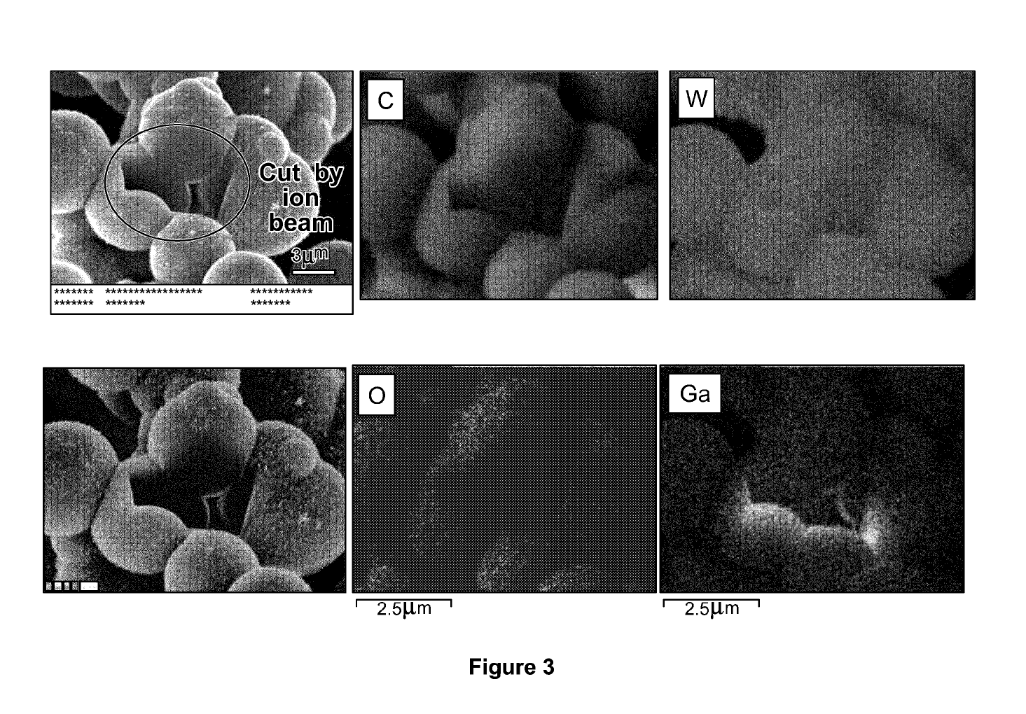

FIG. 2a shows a SEM image of a sample having well-dispersed tungsten carbide nanoparticles. FIG. 3 shows a top view of a sample of tungsten carbide nanoparticles. The carbon support has a smooth spherical structure with a diameter of 3 to 5 μM and contains well dispersed tungsten carbide nanoparticles on its surface. The cross-sectional morphology of individual carbon spheres was examined using cross-beam SEM. A focused Ga+ ion beam operated with an energy of 30 kV and a current of pA was used to mill a selected region (7 μM length×7 μM width×5 μM depth) to reveal the cross-sectional morphology of individual carbon spheres. Although tungsten signal is detected across the entire sphere by EDX mapping, tungsten carbide nanoparticles are only observed on the surface of the carbon sphere. Due to the low resolution of the SEM technique, bright spots on the carbon sphere surface are not necessarily individual particles of tungsten carbide, since several nanoparticles closely packed on a support surface may also result in a bright spot in SEM images at low magnification.

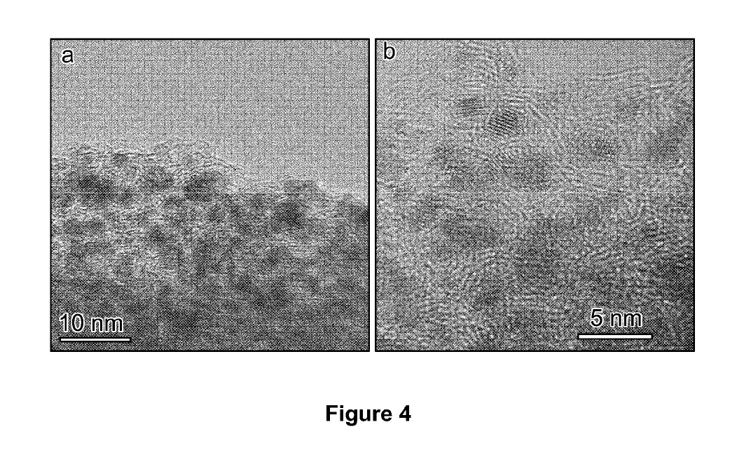

Extensive TEM/STEM analysis was carried out to characterize the dispersion of tungsten carbide nanoparticles on the carbon spheres, as shown in FIGS. 2b, 2c, 2d, and 4. STEM tomography analysis of the sample was also conducted. STEM images were recorded by tilting the sample from −65° to +55° with a 1° increment. The high-angle annular dark field (HAADF) image with large scale range (FIG. 2b) and the representative 3D rendering of the reconstructed tilt series (FIG. 2c) show that the tungsten nanoparticles are uniformly dispersed on the carbon sphere surface with a narrow size distribution of around 3 to 5 nM. The representative bright field TEM images (FIG. 4) also confirm the presence of well-structured tungsten carbide nanoparticles dispersed on carbon.

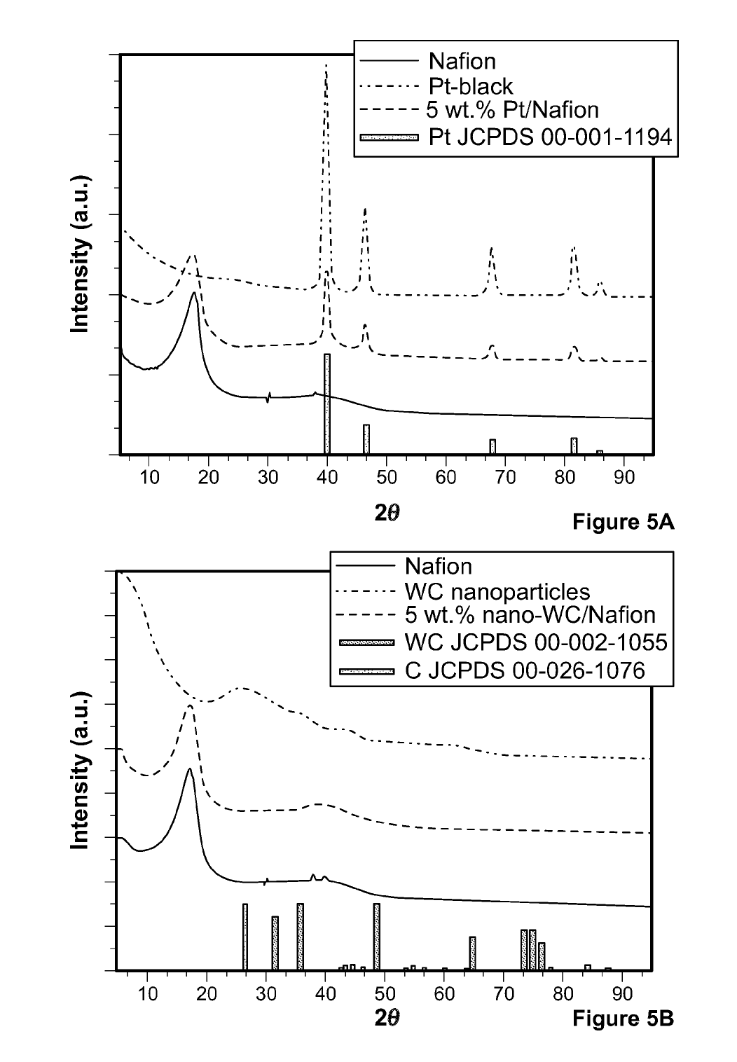

The tungsten carbide nanoparticles were analyzed by applied powder XRD analysis together with lattice indexing of HTREM in order to confirm the crystalline structure, as shown in FIGS. 2d, 5a, and 5b. The high resolution TEM (HRTEM) image with lattice index measurement corresponding to the tungsten carbide (100) surface (FIG. 2d) reveals the hexagonal close-packed α-tungsten carbide structure, which was confirmed by lattice index measurements. FIG. 5a compares XRD patterns of recast Nafion®, platinum black, and a composite Nafion® membrane containing 5% by weight platinum black. Platinum patterns were assigned according to the Joint Committee on Powder Diffraction Standards (JCPDS) 00=001=1194. FIG. 5b compares XRD patterns of recast Nafion®, tungsten carbide nanoparticles, and a composite Nafion® membrane containing 5% by weight of tungsten carbide nanoparticles. Tungsten carbide and carbon patterns were assigned according to the JCPDS files of 00=002=1-55 and 00=026-1076, respectively. The minor intensities of α-tungsten carbide diffraction patterns shown in FIG. 5b indicate small crystalline size.

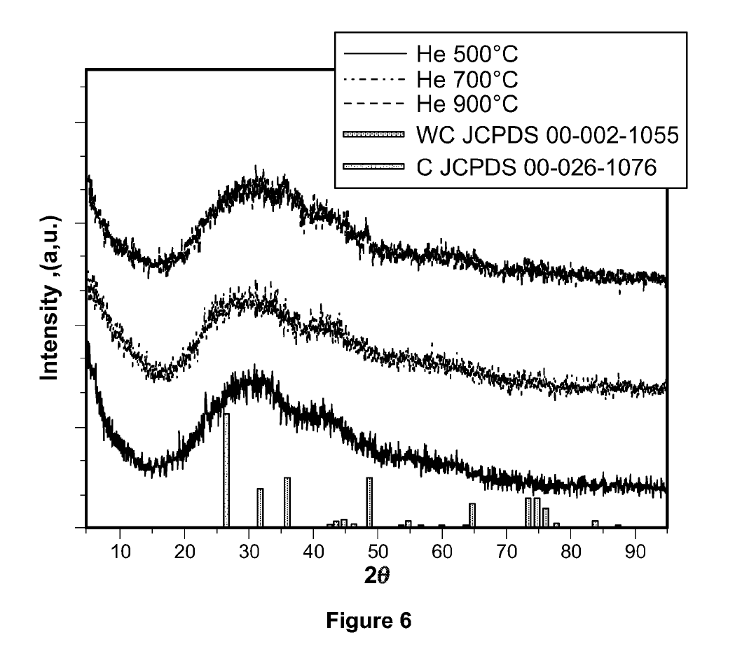

Samples collected after the HTC step of the process according to the present invention were annealed in the presence of helium at temperatures of 500, 700, and 900° C. and subsequently characterized by powder XRD and compared to standard diffraction patterns for tungsten carbide (JCPDS 00-002-1055) and carbon (JCPDS 00-026-1076). As shown in FIG. 6, none of the XRD patterns match well with those of α-tungsten carbide, but are similar to diffraction patterns of tetragonal WO₃, indicating that reduction carburization is a facile and efficient route to carburize the tungsten precursor into the interstitial structure.

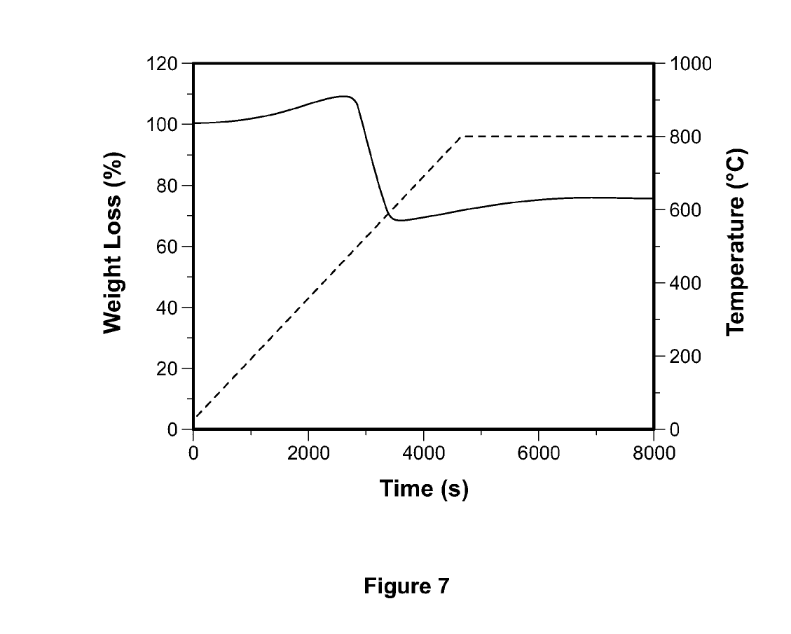

As shown in FIG. 7, thermogravimetric analysis (TGA) of a sample of the tungsten carbide nanoparticles under flowing air was conducted. Operating with the assumption that all tungsten is oxidized to WO₃ and the carbon sphere is combusted, it was estimated that the total loading of tungsten in the tungsten carbide nanoparticles to be around 60% by weight. As shown in Table 1, the surface elemental concentration of the tungsten carbide nanoparticles was calculated from the XPS survey spectrum, which can detect from 2 to 5 nm in depth from the surface. The tungsten carbide nanoparticles contain about 52% by weight of tungsten on top of atomic layers of tungsten carbide and carbon sphere. It is estimated that about 86% of tungsten in the tungsten carbide nanoparticles is carburized near the surface during synthesis.

TABLE 1
Surface Atomic Concentration of Elements of Tungsten Carbide
and WOₓ Nanoparticles from XPS Survey Spectra.

| | Atomic Percentage (%) | | |
|---|---|---|---|
| Catalyst | C | O | W |
| Tungsten Carbide Nanoparticles | 91.09 | 2.22 | 6.69 |
| WOₓ Nanoparticles | 63.79 | 27.59 | 8.62 |

X-Ray Photoelectron Spectroscopy (XPS) Analysis

A Thermo-Fisher K-α+X-ray photoelectron spectrometer equipped with a monochromatic Al-Kα X-ray source (400 μM analysis spot size) was used for XPS analysis.

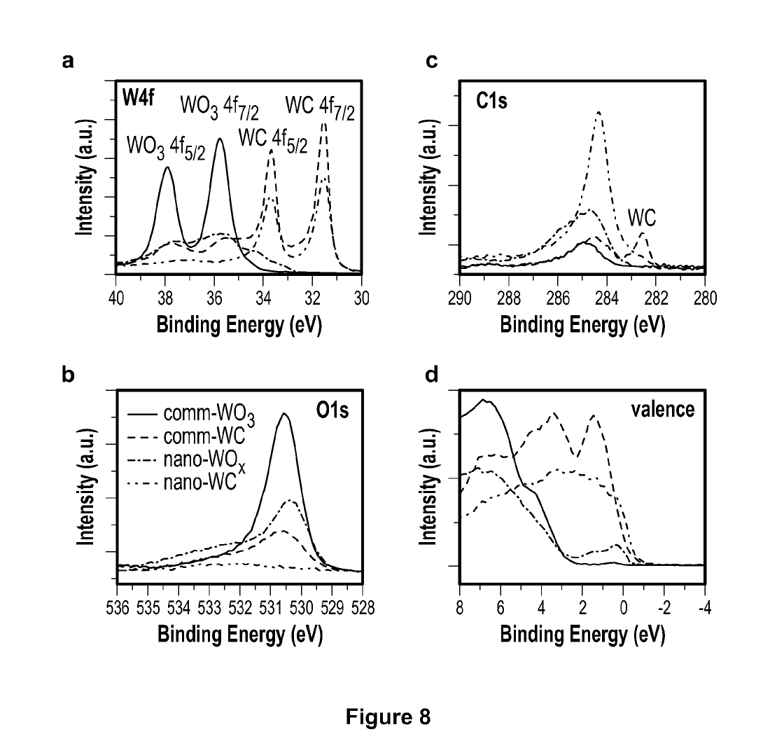

The surface properties of various tungsten-based catalysts were analyzed by XPS, including the tungsten carbide nanoparticles of the present invention. FIG. 8 summarizes the XPS spectra of the W4f, C1s, O1s core level, and fermi level of commercial WO₃, commercial tungsten carbide, WOₓ nanoparticles (sample collected after the HTC step was annealed in helium at 700° C.), and tungsten carbide nanoparticles (passivated in 5% O₂/helium before transfer to XPS analysis). The data demonstrates that the surface of the tungsten carbide nanoparticles is dominated by tungsten carbide: the W4f spectrum in

FIG. 8a demonstrates typical carbidic bonding at about 31.6 and 33.7 eV, which are the doublets of 4f_{7/2} and 4f_{5/2} electrons and consistent with the range values reported in the literature for tungsten carbide surfaces; the C1s spectrum in FIG. 8c shows a minor shoulder peak at around 282.6 eV, which is also found in the commercial tungsten carbide sample and is in agreement with the values assigned to carbidic carbon peak in literature; the density of electronic states of the tungsten carbide nanoparticles is close to that of commercial tungsten carbide, exhibiting a metallic nature with high density at the Fermi level, as shown in FIG. 8d; the O1s spectrum in FIG. 8b shows very minor oxygen features, indicating a tungsten carbide dominated surface. This structural evidence confirms that the process according to the present invention produces tungsten carbide nanoparticles smaller than 5 nm supported on, and separated by, solid carbon material, which prevents nanoparticle sintering and results in a high surface area material.

### Inventive Example 2—Manufacture of a Composite Polymer Electrolyte Membrane

20 mL of 5% Nafion® solution (D-521, ≥0.92 meq/g, Alfa Aesar) was dried at 60° C. to remove the solvent and the resulting Nafion® resin was subsequently dissolved in dimethylacetamide (DMAC) to obtain a Nafion®/DMAC solution. 47 mg (5% by weight, based on the total weight of the membrane) of the tungsten carbide nanoparticles prepared in Example 1 were added to the Nafion®/DMAC solution and the resulting mixture was sonicated for at least 2 hours. The tungsten carbide nanoparticle/Nafion® solution was poured onto a glass plate and heated in an air oven at 120° C. for 4 hours and subsequently in a vacuum oven at 150° C. for 2 hours. The cured membrane having a thickness of 50 μM was lifted off of the glass plate and immersed in 0.5 M sulfuric acid for 2 hours and subsequently rinsed with DI water.

### Comparative Examples 1-3

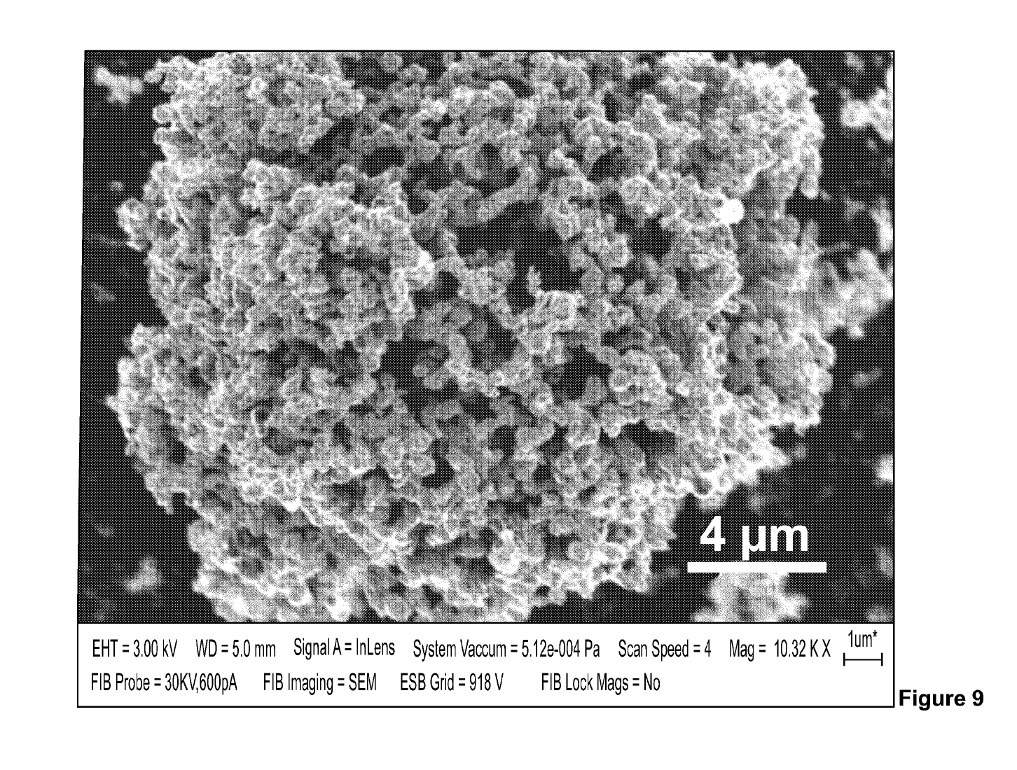

Composite polymer electrolyte membranes were also manufactured from recast Nafion® (Comparative Example 1), commercial platinum black/Nafion® (Comparative Example 2), and commercial tungsten carbide/Nafion® (Comparative Example 3) according to same procedure outlined in Inventive Example 2. All catalysts are present in a concentration of 5% by weight, based on the total weight of the membrane. The average particle size of the commercial tungsten carbide is around 55 nM, as shown in FIG. 9.

### Inventive Example 3—Manufacture of Membrane Electrode Assemblies

The composite membrane of Example 2 was dried and hot-pressed between gas diffusion electrodes (GDEs) having a 0.3 mg/cm² platinum loading at 130° C. for 2 minutes to fabricate the membrane electrode assembly (MEA). The performance of the MEA was tested in a 5 cm² fuel cell.

### Comparative Examples 4-6

GDEs were also manufactured from the composite polymer electrolyte membranes of Comparative Examples 1-3 according to the same procedure outlined in Inventive Example 3.

Fuel Cell Performance

The polarization I-V evaluation of each MEA test was conducted and controlled by a fuel cell test station from Arbin Instruments. The H₂ and O₂ humidifiers were maintained at 70, 55, 41, and 14° C. while the fuel cell temperature was set to 70° C., such that the relative humidity of the inlet gases was 100, 50, 25, and 5%, respectively. The RH was calculated from:

RH=P_{H2O}/P*_{H2O}

Here, P_{H2O} is the ratio of the partial pressure of water vapor in the mixture to the equilibrium vapor pressure of water (P*_{H2O}) at a given temperature. Gas supply line temperatures were maintained 5° C. higher than the fuel cell temperature to prevent condensation of water vapor. Hydrogen fuel and oxygen were fed in co-flow to the fuel cell. H₂ and O₂ flow rates were 200 mL/minute and 400 mL/minute, respectively. The fuel cell tests were conducted at ambient pressure. The fuel cell was conditioned for 8 hours at a current density of 1 A/cm² before collecting performance data. For each humidify, the fuel cell was discharged at 0.5 A/cm² for 1 hour and held at OCV for 10 minutes before I-V evaluation.

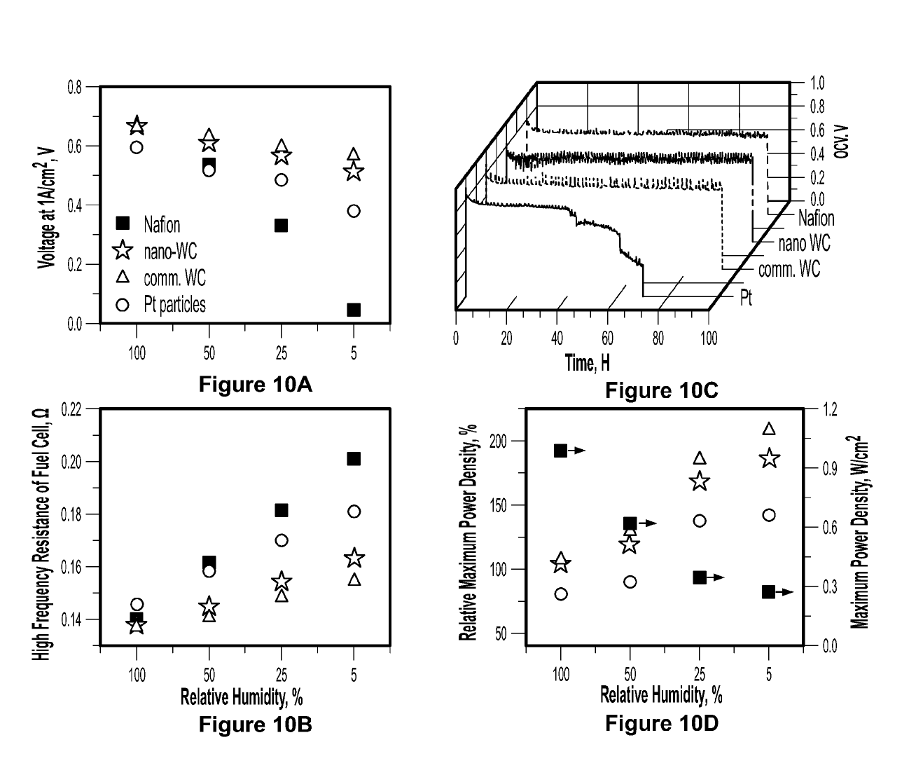

FIG. 10a shows fuel cell performance at a current density of 1 A/cm² and 5, 25, 50, and 100% relative humidity of recast Nafion® membrane (squares), 5% by weight commercial tungsten carbide/Nafion® composite membrane (triangle), 5% by weight platinum/Nafion® composite membrane (circle), and a composite membrane of Nafion® and 5% by weight tungsten carbide nanoparticles (star). FIG. 10a demonstrates that humidity has a strong effect on the recast baseline Nafion® membrane, which lost most of the power at 5% RH and underscores the main reason of applying external humidity at the expense of increasing mass, size, and cost of PEMFCs. Upon introducing catalysts in the membrane, the fuel cell performance is improved due to the water generation from crossover H₂/O₂ to humidify the bulk Nafion® membrane and thereby increase efficiency.

FIG. 10b shows proton conductivity of fuel cells using of recast Nafion® membrane (squares), 5% by weight commercial tungsten carbide/Nafion® composite membrane (triangle), 5% by weight platinum/Nafion® composite membrane (circle), and a composite membrane of Nafion® and 5% by weight tungsten carbide nanoparticles (star) MEAs, as measured by two-probe electrochemical impedance spectroscopy (EIS). Two-probe EIS measurements were carried out using a VersaSTAT 3 potentiostat (Princeton Applied Research) to fuel cells with VersaStudio data acquisition software in the frequency range of from 10,000 Hz to 0.1 Hz. Impedance data were fit to a typical Randles circuit using ZView plotting software (Scribner Associates). All experiments were carried out at a cell temperature of 70° C., with flow rates of 100 mL/minute of H₂ and 200 mL/minute of O₂.

Membranes according to the present invention can significantly improve proton conductivity at low RH, as demonstrated in FIG. 10b. At high RH, the composite membranes show minor improvement of fuel cell performance, likely due to the high proton conductivity owing to the external water. Upon introducing tungsten carbide nanoparticles into the membrane, fuel cell performance improves by about 20% (at 50% RH) and 80% (at 5% RH) compared to the baseline Nafion® membrane and approaches that of recast membrane containing 5 weight % of platinum. Although the commercial tungsten carbide composite membrane surpasses the pristine Nafion® membrane at low humidity, the interparticle pores inside bulk tungsten carbide clusters limit the access of Nafion® precursor and the transport of protons through the pores of the bulk tungsten carbide at higher RH. This problem is mitigated by the use of tungsten carbide nanoparticles in the Nafion® membrane because they provide much higher density of active sites and prevent transport limitations by being located on the surface of non-porous carbon spheres. Even though the platinum composite membrane has the highest peak power density, further increases in power density may be possible by optimizing the loading of tungsten carbide nanoparticles in the polymer membrane.

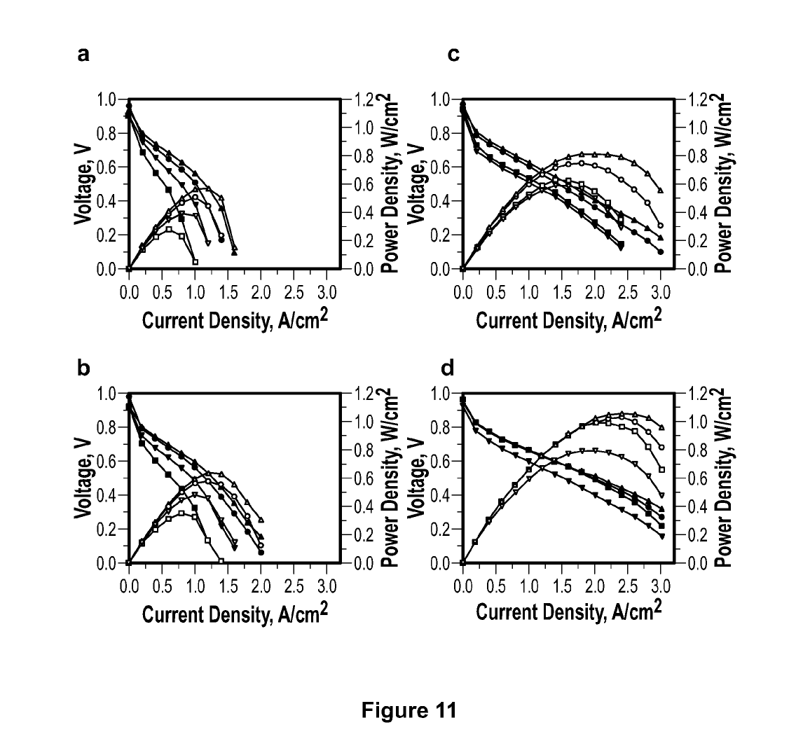

FIG. 11 demonstrates the fuel cell performance of Inventive Example 3 (circles) and Comparative Examples 4 (squares), 5 (up triangles), and 6 (down triangles). Comparative Example 5 exhibits the greatest conservation of performance when the humidity drops from 100% RH to 5% RH. Inventive Example 3 exhibits a similar, but lower, conservation of performance to that of Comparative Example 5. This is due to the lower comparable activity of the tungsten carbide nanoparticle catalyst compared to that of platinum black. However, the degree of conservation is still significant considering the low cost of the tungsten carbide nanoparticle catalyst and the relative positive effect on membrane durability. Comparative Example 4, which lacks self-hydrating function, exhibits the largest decrease in performance (from 1 W/cm2 at 100% RH to 0.3 W/cm2 at 5% RH).

Fuel Cell Durability

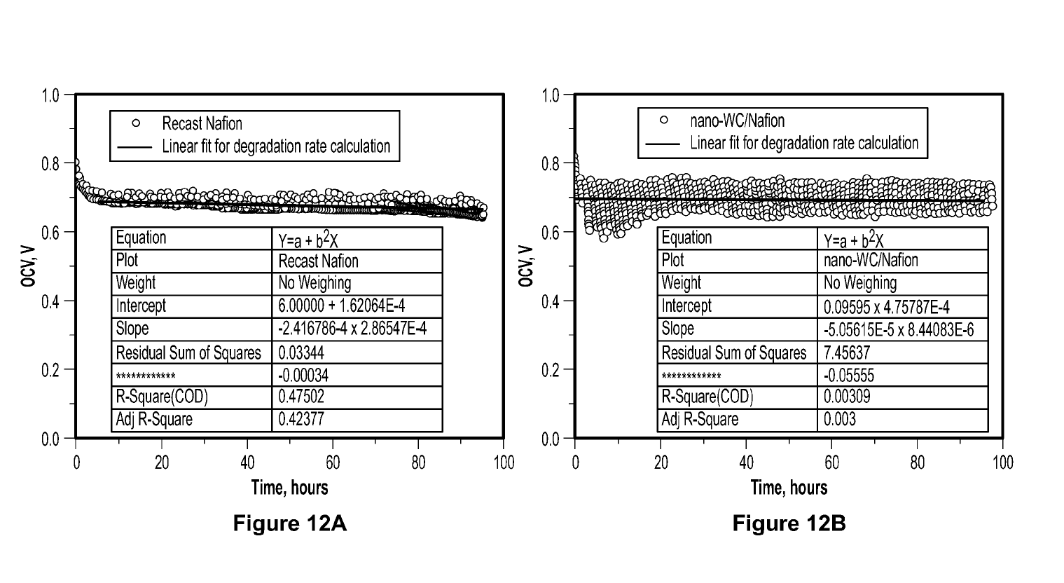

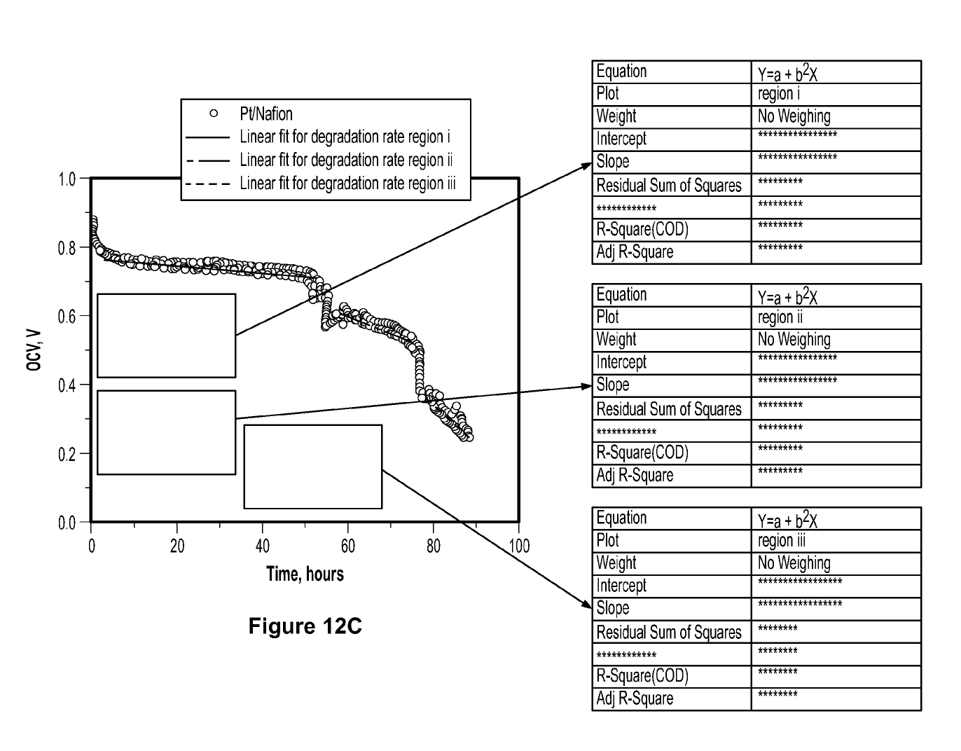

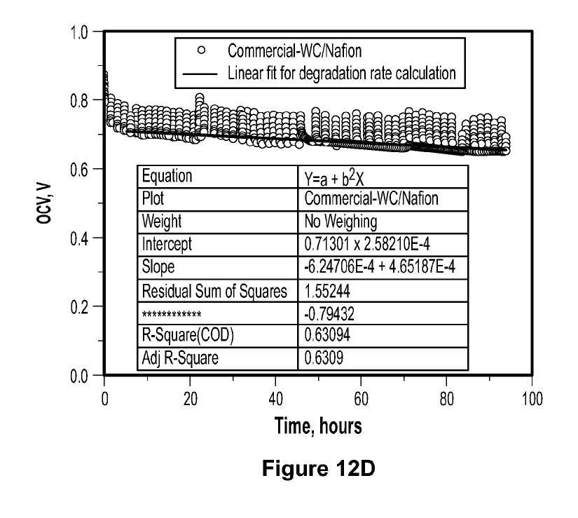

In order to evaluate the durability of the membranes, a series of accelerated fuel cell operating tests were carried out according to DOE protocol at 90° C. and 35% relative humidity under open circuit voltage conditions for 100 hours, as shown in FIG. 10c. High temperature and low humidity have been recognized as the most effective conditions for fuel cell degradation and the OCV test, which results in high gas permeability and more free radicals, is believed to accelerate the chemical degradation of the membrane. FIG. 10d shows relative maximum power density (P_{C}/P_{N}×100, where P_{C} and P_{N} are the maximum power densities of the composite membranes and pristine Nafion® membrane, respectively) measured at different relative humidity. As demonstrated in FIG. 10d, a slight decline of voltage was observed for the pure recast Nafion® membrane after 100 hours with a degradation rate of 0.285±0.003 mV/h. See FIG. 12a. The degradation rate of Nafion® membrane with commercial tungsten carbide is 0.625±0.005 mV/h, which is slightly faster than the recast Nafion® membrane, most likely due to the large particle size of the tungsten carbide, which causes higher initial gas crossover. See FIG. 12d. The platinum composite membrane exhibited a slow decreasing voltage after 24 hours, with a degradation rate of 1.38±0.01 mV/h, followed by an accelerated voltage drop (degradation rates of 6.09±0.04 mV/h and 14.3±0.14 mV/h, respectively). See FIG. 12c. In contrast, the composite membrane containing tungsten carbide nanoparticles exhibited excellent stability for 100 hours without a discernible decline of voltage. As shown in FIG. 12b, a slow 0.05±0.008 mV/h degradation rate was observed over the composite membrane containing tungsten carbide nanoparticles, which is 1/5 of the rate of recast Nafion® alone. Clearly, a minor loading of nonprecious catalyst can profoundly enhance the PEMFC performance and durability.

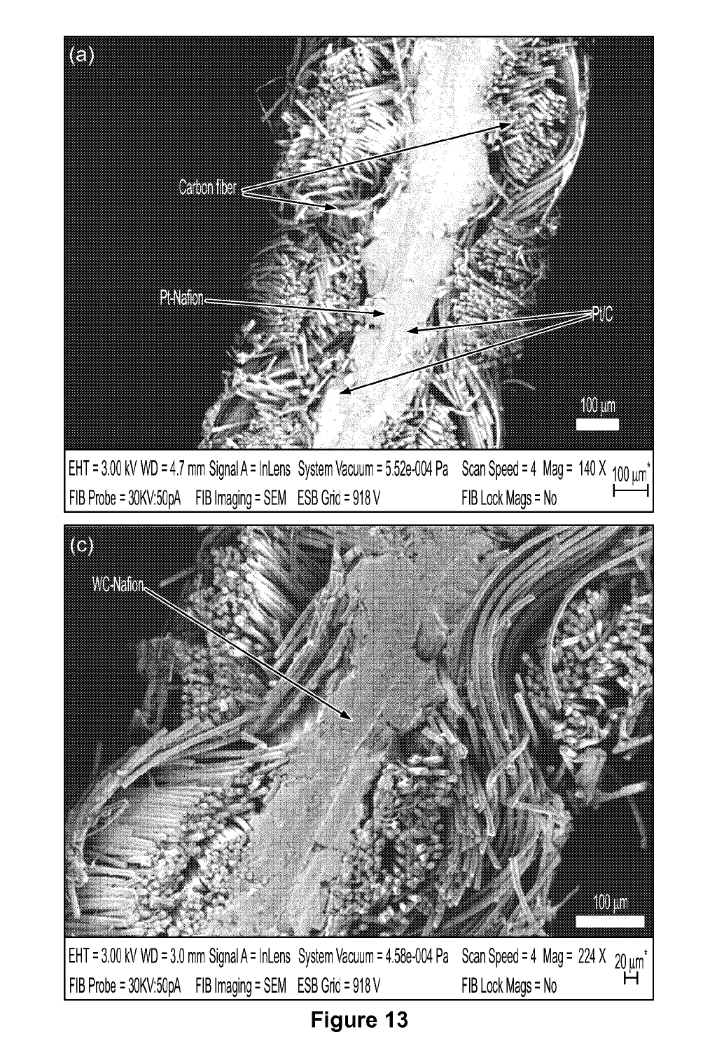

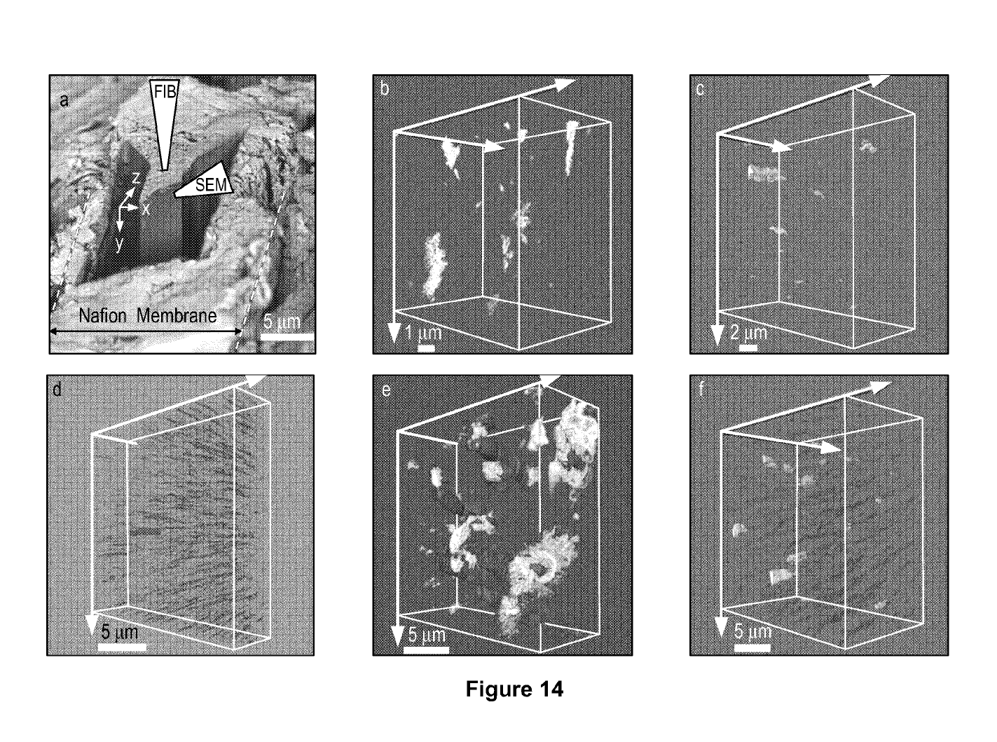

The membranes were further analyzed using cross-sectional SEM images (FIG. 13) and FIB-SEM tomography (FIG. 14) to reveal and compare the detailed 3D microstructure of fresh and used membranes. The pinhole/vacancy, Nafion®, and catalyst can be distinguished by the differences in their contrast in each slice of SEM image. After alignment of all sequential images, the rendering surfaces of vacancy and catalyst of the composite membrane are reconstructed. In FIG. 14, the white regions correspond to the catalyst (platinum or tungsten carbide nanoparticles) embedded in the Nafion® membrane, while voids within the Nafion® membrane are depicted in red. FIG. 14a shows a representative region of a PEM sample during FIB-SEM tomographic investigation in which the milled region is identified. The focused ion beam removes a 12 nM thick layer of the membrane during each pass, while an electron beam records its SEM image. FIGS. 14b through 14f present the 3D morphology of fresh and used membranes reconstructed from the FIB milled cube. FIGS. 14b and 14c show 3D reconstructions of fresh platinum/Nafion® and tungsten carbide nanoparticle/Nafion® composite membranes, respectively. FIGS. 4d, 4e, and 4f show 3D reconstructions of used Nafion® membrane and used platinum/Nafion® and tungsten carbide nanoparticle/Nafion® composite membranes, respectively, after 100 hours of fuel cell operation. Both recast Nafion® (FIG. 14d) and composite Nafion®/5 weight % tungsten carbide nanoparticle (FIG. 14f) membranes showed in-plane pinholes throughout the membrane after 100 hours of the accelerated durability test. Because the durability test was conducted at 35% relative humidity in both the anode and the cathode streams, diffusion-induced water flux through the membrane thickness is not expected. Therefore, pinholes form along the in-plane direction, the primary direction of water flux within the membrane (from inlet to outlet). FIGS. 14d and 14f demonstrate an almost identical pinhole morphology—the voids are small and highly aligned in the in-plane direction. Importantly, the voids in FIG. 14f do not show any preferential clustering adjacent to the tungsten carbide nanoparticles. In contrast, in the platinum-based membrane, the pinholes are large and highly clustered around the platinum catalyst. See FIG. 14e. This finding hints to yet another role of platinum—aside from hydrating the membrane (a beneficial effect), it produces radicals that locally degrade the membrane (an undesired effect).

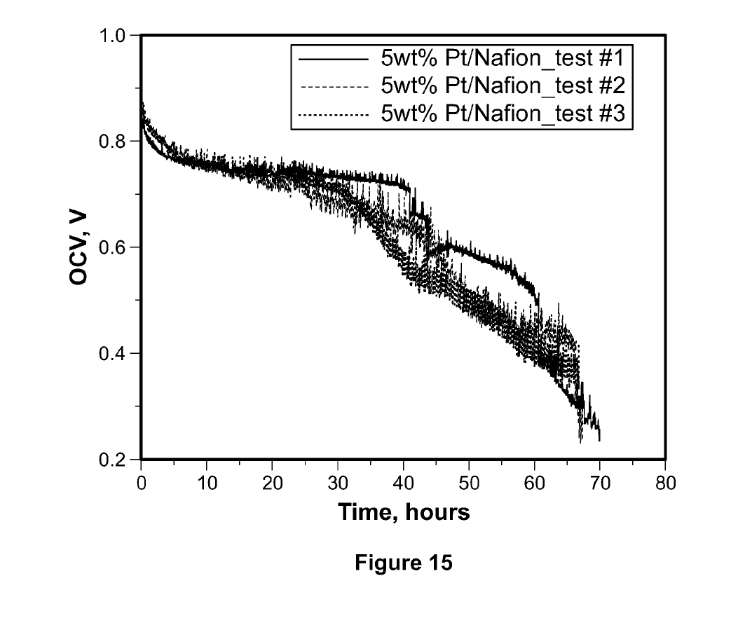

FIG. 12, which shows the linear fit of accelerated durability tests of recast Nafion® membrane (a) and composite Nafion® membranes incorporating tungsten carbide nanoparticles (b), platinum (c), and commercial tungsten carbide catalyst (d). FIG. 12c shows that the degradation rate for regions i, ii, and iii is 1.38±0.01 mV/h, 6.09±0.04 mV/h and 14.3±0.14 mV/h, respectively. This degradation is due to major defects formed during the test from higher gas crossover. The accelerated durability tests were conducted according to the DOE protocol at 90° C. and 35% RH. Fuel cells were first conditioned at 1A/cm² for 8 hours at 100% RH and 70° C. The fuel cell temperature was then raised to 90° C., and the relative humidity was reduced to 35%. When the fuel cell and humidifiers reached the desired temperature, the fuel cell was switched to OCV, and the durability test started. The OCV was recorded for evaluation of durability. This test is designed to be much faster than the conventional test, so that the lifespan of different membranes can be studied in laboratories, usually within 100 to 300 hours. Since failure of platinum/Nafion® composite membranes occurs within 100 hours, tests were conducted for 100 hours. FIG. 15 demonstrates that the failure of platinum/Nafion® composite membranes during tests on multiple samples is repeatable. All three samples showed similar trends and failed at approximately 70 hours. The slight variability in the OCV versus time profiles is due to the necessarily random formation of pinholes through which reactant gas crosses over, leading to random drops in OCV and eventually, failure. In light of such randomness, the three profiles shown are quite similar.

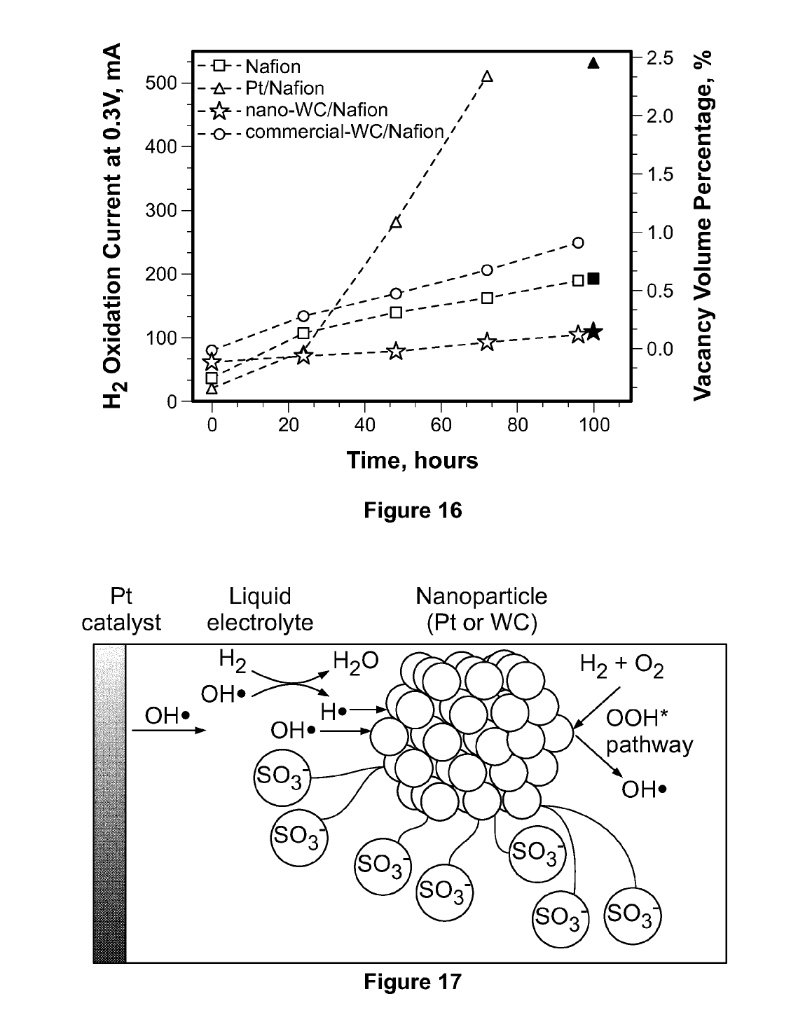

The pinhole void fractions of the used membranes were estimated using 3D tomographic analysis, as summarized in FIG. 14. The results are in agreement with the gas crossover quantifications measured during stability tests. As summarized in FIG. 16, gas crossover of recast Nafion® membrane (square) and composite membranes of platinum (triangle), tungsten carbide nanoparticles (star), and commercial tungsten carbide (circle) was tested by the linear scan voltammetry (LSV) method from 0 to 0.7V with a scan rate of 2 mV/s on an AMETEK Versa STAT 3 station using 100% RH nitrogen and hydrogen in the working and counter electrodes, respectively. The hydrogen electrode was also used as the reference electrode. Nitrogen and hydrogen flow rates were both set to 100 mL/minute. The H₂ crossover from reference electrode surface to working electrode surface was then oxidized when H₂ moves away from the surface and new H₂ molecules come into contact with the surface of the working electrode. H₂ oxidation current at 0.3 V was used to compare the H₂ crossover of different membranes. Platinum/Nafion® composite membrane exhibited the fastest increase of gas crossover during the durability test due to fastest degradation of the membrane. The tungsten carbide nanoparticle/Nafion® composite membrane is the most stable one with the least gas crossover. The smaller void fraction in the tungsten carbide/Nafion® sample after the durability test is consistent with its smaller gas crossover shown in FIG. 16.

From the FIB-SEM and gas crossover measurements, it may be concluded that the tungsten carbide nanoparticles according to the present invention do not cause damage to Nafion® membranes, but rather enhances their stability. In contrast, platinum catalyst causes severe damage to Nafion® membranes, with defects forming around the platinum black particles, possibly due to the high concentration of free radicals generated from the catalyst during the crossover H₂/O₂ reaction. Hence, the tungsten carbide nanoparticles are able to improve fuel cell performance by enhancing the self-hydration ability of the membrane, at low cost and without harmful effect on it stability.

Periodic Density Functional Theory (DFT) Calculations

With the aim of revealing the intrinsic mechanisms of the reactions occurring on the embedded tungsten carbide nanoparticles and rationalize the enhanced stability of the membrane, DFT calculations were conducted. Different mechanisms that can influence the concentration of OH. and H. radicals in solution, which are believed to retard Nafion® via removal of —SO3⁻ groups, are proposed. A schematic of the reaction pathways is shown in FIG. 17. First, OH. produced from the platinum electrocatalyst cathode may be directly captured on the nanoparticle surface via adsorption:

OH.+*→OH* (1)

where * represents a vacant site on the nanoparticle. In addition, H. may be produced as a result of OH. donating its oxygen to H₂. H. may then be captured by the nanoparticle through a similar adsorption step:

OH.+H₂→H.+H₂O (2)

H.+*→H* (3)

The production of H. from OH. has been reported to be exothermic of a low energy barrier. Although H. has a short lifetime, H. produced in solution can still affect the stability of Nafion®. Aside from adsorbing OH. and H. from solution, OH. is produced on the membrane catalyst during H₂ oxidation and can desorb to solution. This is of particular concern, since in situ production of OH. and H. could lead to major deterioration of Nafion® membrane stability. The reaction mechanism of OH. production considered herein on both tungsten carbide and platinum is analogous to that reported in the literature.

Periodic DFT calculations were performed using the Vienna Ab initio simulation package (VASP, version 5.3.2). The Perdew-Burke-Ernzerhof (PBE) exchange-correlation functional was used to approximate the exchange-correlation energy. The core electrons were represented with the projector augmented wavefunction (PAW) method and a plane-wave cutoff of 400 eV was used for the valence electrons. The Methfessel-Paxton method of electron smearing was used with a smearing width of 0.1 eV. All geometry optimizations were performed using the conjugate gradient algorithm as implemented in VASP. The forces and energies were converged to 0.05 eV Å-1 and 10-4 eV, respectively. All calculations were performed spin-polarized.

To model the surface sites of the platinum and tungsten carbide nanoparticles embedded within the Nafion® structure, the surface energies of various planes of the platinum and tungsten carbide bulk structures were calculated to determine the most relevant experimental surfaces to model. The platinum (111) plane and the tungsten carbide (100) plane were found to be the lowest energy surfaces. Platinum (111) is widely reported to have the lowest surface energy of the platinum surfaces. The energy of the (111), (100), and (110) surfaces of tungsten carbide was computed in accordance with the literature:

γ=E_{surf}−N_{bulk}E_{bulk}/2A

where E_{surf} is the total energy from DFT, N_{bulk} is the number of bulk units, E_{bulk} is the energy of one bulk unit, and A is the area of the surface. The surface energy of each low-index surface of tungsten carbide is provided in Table 2.

TABLE 2
Surface Energies of the Low-Index Tungsten Carbide Surfaces.

| Surface | Surface Energy (J m⁻²) |
|---|---|
| (100) | 3.89 |
| (111) | 4.03 |
| (110) | 4.37 |

For all surface calculations, a 3×3 periodic unit cell was used. In the z-direction, a vacuum layer of 15 Å was included. A 3×3×1 Monkhorst-Pack k-point sampling of the Brillouin-zone was implemented. Zero-point energy and temperature corrections, performed at 298.15K, were taken from previously published data. Higher accuracy calculations (5×5×1 k-point sampling and a 500 eV plane-wave cutoff) were also performed for H. and OH. adsorption on platinum (111) and tungsten carbide (100). In all cases, the adsorption energy changed by less than 0.05 eV.

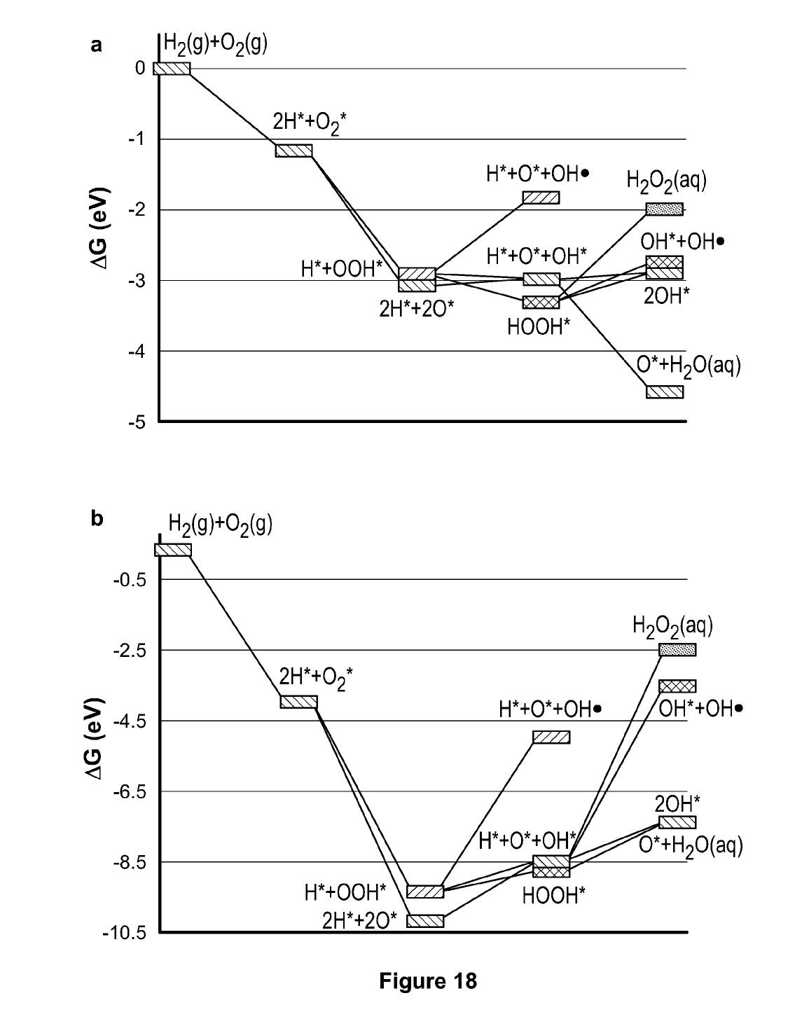

Potential free energy diagrams for the in-situ production of OH. were constructed. Zero-point and entropic corrections to the DFT energies were taken from previously published results. The results obtained for the production of OH. on platinum (111) and tungsten carbide (100) are provided in FIG. 18. For platinum (111), shown in FIG. 18a, the production of OH. through an adsorbed HOOH* intermediate is mildly uphill in free energy (+0.56 eV). Note that all reaction energies computed herein correspond to the low coverage of 1/9 ML. This thermodynamic barrier could likely be overcome on platinum at higher coverages due to repulsive lateral interactions between adsorbates.

In contrast, the potential free energy diagram for tungsten carbide (100) (FIG. 18b) indicates that the lowest energy pathway to produce OH. is a co-adsorbed H* and OOH* intermediate whereby the reaction is strongly endergonic (+4.01 eV). While the thermodynamic barrier for desorption of OH. will decrease at high coverage due to lateral interactions, previous results indicate that these interaction energies are relatively mild with a pairwise O—O interaction of 0.16 eV on a platinum (100) surface. Therefore, the production of OH. through this mechanism should be thermodynamically unfavorable even at high coverages on tungsten carbide (100).

DFT calculations demonstrate that tungsten carbide binds OH. and H. more strongly than platinum (adsorption is more exergonic on tungsten carbide by 2.29 eV and 0.63 eV, respectively) and, thus, binding of these species is facilitated by tungsten carbide. As a result, tungsten carbide more efficiently captures radical species from solution produced on the platinum electrode. Investigation of the ability of the platinum and tungsten carbide nanoparticles to produce OH. in situ clearly demonstrates that production of OH. is highly unfavorable relative to the oxidation of the tungsten carbide surface by O*. The potential energy diagram in FIG. 18a of the OH. formation mechanism on platinum (111) demonstrates that the most favorable pathway for OH. formation is the dissociation of HOOH* to form adsorbed OH* and an OH. radical in solution, with a reaction free energy of +0.56 eV. In contrast, the potential energy diagram for the OH. formation mechanism on tungsten carbide (100) (FIG. 18b) demonstrates that the most favorable pathway for OH. formation is the dissociation of OOH* to form O* and an OH. radical in solution, with a reaction free energy of +4.01 eV. As a result, a significantly larger thermodynamic barrier exists to form OH. radicals on tungsten carbide (100) than on platinum (111). Therefore, DFT calculations indicate that incorporation of tungsten carbide nanoparticles according to the present invention can benefit the stability of the Nafion® structure by adsorbing radical species already in solution released from the cathode and by being relatively inactive towards OH. production.

### Inventive Example 4—Manufacture of Fuel Cell Electrodes

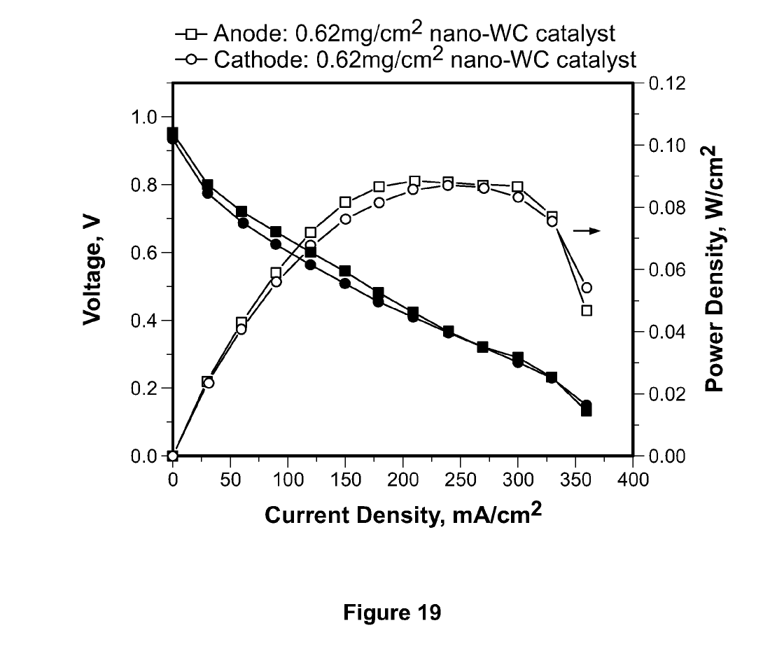

Fuel cell electrodes were manufactured from the tungsten carbide nanoparticles according to the present invention by air spraying a mixture of tungsten carbide nanoparticles, Nafion®, and isopropyl alcohol onto commercial gas diffusion media (i.e., carbon cloth with a microporous layer). The loading of the tungsten carbide nanoparticles is 0.62 mg/cm² and the loading of Nafion® is 25% by weight. The electrodes were tested as both anode or cathode, with commercial Pt/C electrode (0.3 mg/cm²) on the corresponding cathode or anode. The testing temperature of the cell is 70° C. and 100% RH with 200 mL/minute H₂ and 400 mL/minute O₂. As demonstrated by the polarization curves in FIG. 19, similar performance was observed regardless of whether the tungsten carbide nanoparticles were used on the anode or the cathode. The peak power density of the fuel cells is about 0.09 W/cm², indicating catalytic activity for H₂ oxidation and O₂ reduction.

### Inventive Example 5—Synthesis and Electron Microscopy Analysis of Molybdenum Carbide Nanoparticles

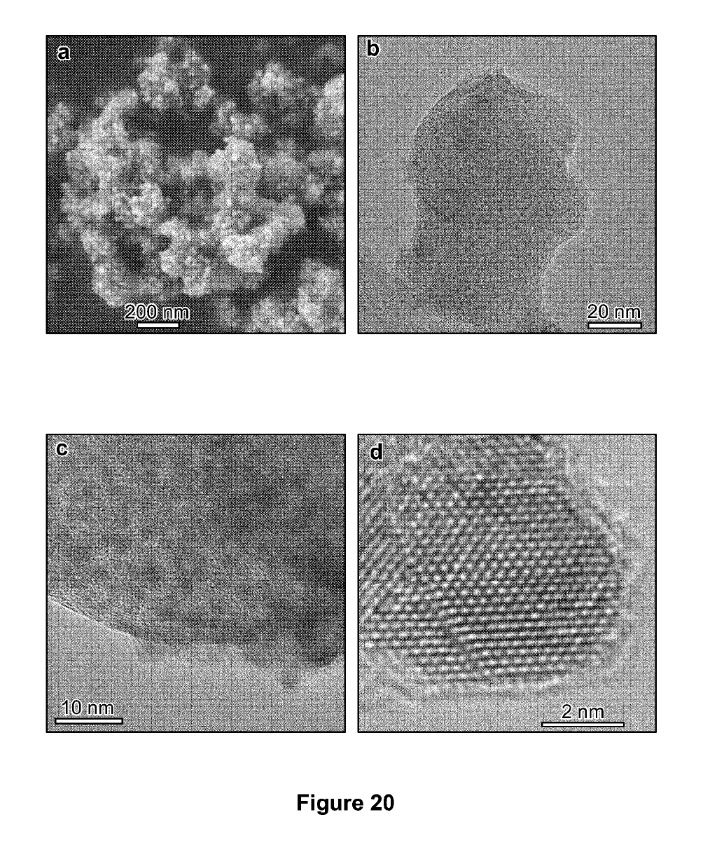

Molybdenum carbide (Mo₂C) nanoparticles were prepared according to the process of the present invention, with the exception that ammonium heptamolybdate was used as the transition metal precursor and the TPRC process was performed at 650° C. Representative SEM and TEM images of these nanoparticles are shown in FIG. 20. FIG. 20a shows a SEM image of Mo₂C nanoparticles (bright dots) dispersed on carbon (grey spheres). FIG. 20b shows a low magnification TEM image of a representative carbon sphere fragment with highly dispersed Mo₂C nanoparticles (black dots). FIG. 20c shows a high magnification TEM image observing the edge region of the carbon sphere with narrow distributed Mo₂C nanoparticles (black spots). FIG. 20d shows a high resolution TEM image of a representative Mo₂C nanoparticle. As can be seen from FIG. 20b, which is a fragment of the as-prepared carbon sphere grounded and deposited on the grid for TEM analysis, the black dots dispersed on carbon sphere are assigned to molybdenum carbide. This was confirmed by TEM analysis at higher magnification (FIG. 20c) and atomic resolution (FIG. 20d) with lattice indexing, which shows the hexagonal closed packed β-Mo₂C structure.

1. A microparticle comprising carbon and a plurality of nanoparticles comprising one or more transition metal compounds selected from the group consisting of transition metal carbides, transition metal nitrides, transition metal sulfides, transition metal phosphides, transition metal carbonitrides, transition metal sulfonitrides, transition metal carbosulfides, transition metal phosphocarbides, transition metal phosphonitrides, transition metal phosphosulfides, transition metal carbosulfonitrides, transition metal carbophosphonitrides, transition metal phosphosulfonitrides, transition metal carbophosphosulfonitrides, and interstitial derivatives thereof, wherein the plurality of nanoparticles are supported on the surface of the microparticle.

2. The microparticle of claim 1, wherein the microparticle further comprises one or more transition metals selected from the group consisting of tungsten, nickel, iron, cobalt, molybdenum, rhodium, iridium, zinc, copper, manganese, chromium, palladium, and platinum.

3.-4. (canceled)

5. The microparticle of claim 1, wherein the microparticle has an average particle size of 30 μM or less.

6.-9. (canceled)

10. The microparticle of claim 1, wherein the nanoparticles has an average particle size of 5 nM or less.

11. (canceled)

12. The microparticle of claim 1, wherein the transition metal of the one or more transition metal compounds is selected from the group consisting of tungsten, nickel, iron, cobalt, molybdenum, rhodium, iridium, zinc, copper, manganese, chromium, palladium, platinum, and combinations thereof.

13. The microparticle of claim 12, wherein the nanoparticles comprise tungsten carbide.

14. The microparticle of claim 1, wherein the interstitial derivative comprises one or more transition metals selected from the group consisting of tungsten, nickel, iron, cobalt, molybdenum, rhodium, iridium, zinc, copper, manganese, chromium, platinum, and palladium.

15. The microparticle of claim 1, wherein the nanoparticles have a core/shell structure.

16. A membrane comprising a plurality of microparticles in accordance with claim 1, wherein the transition metal of the transition metal compound is selected from the group consisting of tungsten, cobalt, molybdenum, rhodium, iridium, zinc, copper, manganese, chromium, and combinations thereof.

17. The membrane of claim 16, wherein the membrane comprises an ionomer comprising one or more functional groups selected from the group consisting of sulfonic acid/sulfonate groups, phosphonic acid/phosphonate groups, and carboxylic acid/carboxylate groups.

18. (canceled)

19. The membrane of claim 16, wherein the membrane comprises a poly(perfluorosulfonic acid).

20. The membrane of claim 19, wherein the poly(perfluorosulfonic acid) is a tetrafluoroethylene-based copolymer.

21. The membrane of claim 16, wherein the membrane further comprises one or more transition metals selected from the group consisting of tungsten, cobalt, molybdenum, rhodium, iridium, zinc, copper, manganese, chromium, platinum, and palladium.

22. (canceled)

23. The membrane of claim 16, wherein the microparticles are present in the membrane in a concentration in the range of from 1% to 10% by weight, based on the total weight of the membrane.

24.-26. (canceled)

27. The membrane of claim 16, wherein the membrane has a thickness in the range of from 10 μM to 100 μM.

28. (canceled)

29. The membrane of claim 16, wherein the membrane is reinforced.

30. The membrane of claim 16, wherein the membrane is reinforced with polytetrafluoroethylene and/or carbon nanotubes.

31. (canceled)

32. A process for preparing a microparticle comprising carbon and a plurality of nanoparticles comprising one or more transition metal compounds selected from the group consisting of transition metal carbides, transition metal nitrides, transition metal sulfides, transition metal phosphides, transition metal carbonitrides, transition metal sulfonitrides, transition metal carbosulfides, transition metal phosphocarbides, transition metal phosphonitrides, transition metal phosphosulfides, transition metal carbosulfonitrides, transition metal carbophosphonitrides, transition metal phosphosulfonitrides, and transition metal carbophosphosulfonitrides, comprising the steps of:
(a) subjecting a mixture of (1) one or more precursors comprising a transition metal and (2) a precursor comprising carbon to hydrothermal carbonization to form an intermediate; and
(b) subjecting the intermediate formed in (a) to temperature-programmed reduction-carburization, temperature-programmed reduction-nitridation, a temperature-programmed reduction-sulfidation and/or a temperature-programmed reduction-phosphidation to form a microparticle comprising carbon and a plurality of nanoparticles comprising a transition metal carbide, transition metal nitride, transition metal sulfide, transition metal phosphide, transition metal carbonitride, transition metal sulfonitride, transition metal carbosulfide, transition metal phosphocarbide, transition metal phosphonitride, transition metal phosphosulfide, transition metal carbosulfonitride, transition metal carbophosphonitride, transition metal phosphosulfonitride, and/or transition metal carbophosphosulfonitride.

33. The process of claim 32, wherein the process forms a microparticle comprising carbon wherein the plurality of nanoparticles are supported on the surface of the microparticle.

34. The process of claim 32, wherein the transition metal of the precursor comprising a transition metal is selected from the group consisting of tungsten, nickel, iron, cobalt, molybdenum, rhodium, iridium, zinc, copper manganese, chromium, platinum, palladium, and combinations thereof.

35. The process of claim 32, wherein the precursor comprising a transition metal comprises ammonium metatungstate hydrate.

36. The process of claim 32, wherein the precursor comprising carbon is a water-soluble carbohydrate obtained from food and/or lignocellulosic biomass.

37.-38. (canceled)

39. The process of claim 32, further comprising ball milling the intermediate formed in step (a) prior to step (b).

40. The process of claim 32, further comprising post-treatment of the microparticle formed in (b) to form an interstitial derivative of the transition metal carbide, transition metal nitride, transition metal sulfide, transition metal phosphide, transition metal carbonitride, transition metal sulfonitride, transition metal carbosulfide, transition metal phosphocarbide, transition metal phosphonitride, transition metal phosphosulfide, transition metal carbosulfonitride, transition metal carbophosphonitride, transition metal phosphosulfonitride, and/or transition metal carbophosphosulfonitride.

41. The process of claim 40, wherein the post-treatment is selected from the group consisting of atomic layer deposition and colloidal synthesis.

42. The process of claim 40, wherein the interstitial derivative comprises one or more transition metals selected from the group consisting of tungsten, nickel, iron, cobalt, molybdenum, rhodium, iridium, zinc, copper, manganese, chromium, platinum, and palladium.

43. A fuel cell comprising an anode, a cathode, an anode catalyst, and a membrane in accordance with claim 16.
